(19) United States
(12) Patent Application Publication
(10) Pub. No.: US 2022/0263329 A1
(43) Pub. Date: Aug. 18, 2022

(54) Charger System for Electronic Devices

(71) Applicant: Volonic, Inc., Newport Beach, CA (US)

(72) Inventors: Chung Wei, Walnut Creek, CA (US); David Danielson, Irvine, CA (US); Shawn Dougherty, Newport Beach, CA (US)

(73) Assignee: Volonic, Inc., Newport Beach, CA (US)

(21) Appl. No.: 17/651,785

(22) Filed: Feb. 18, 2022

Related U.S. Application Data
(60) Provisional application No. 63/151,037, filed on Feb. 18, 2021.

(51) Int. Cl. H02J 7/00; H01R 31/06; H01R 13/62; H01R 13/52; H01R 13/648

(52) U.S. Cl. CPC H02J 7/0042; H01R 31/06; H02J 2207/30; H01R 13/5213; H01R 13/648; H01R 13/6205

(57) ABSTRACT

The present disclosure relates to a charger and a charger system, a charger having a removeable cover, as well as particular charger and adapter engagement configurations that provide robust, operative, and resealable association between the charger and adapter. The present disclosure also provides users the ability to forego a fixed, factory-provided aesthetic appearance of their chargers by providing the ability to customize the charger in accordance with an end-user's own preference/style.

### FIELD

This 35 U.S.C. § 111 patent application claims the benefit of priority and is entitled to the filing date pursuant to 35 U.S.C. § 119(a) of U.S. Patent Application 63/151.037, filed Feb. 18, 2021, the content of which is hereby incorporated by reference in its entirety.

The present disclosure relates generally to chargers and systems and, in various aspects, relates to elements of charger and adapter engagement configurations that provide operative association of the charger with at least one of a plurality of adaptor assemblies that have an adaptor plug standard that is different than an electrical plug standard of an integral plug of the charger. In another aspect, the present disclosure provides improved damage protection and personalization of the charger and/or system.

### BACKGROUND

Various consumer electronic products, such as laptops, personal digital assistants (PDA), mobile phones and MP3 players, for example, utilize a charger that is plugged into an electrical power outlet in order to store a charge to power these devices and/or charge the internal batteries thereof. Chargers having various integral plug configurations for insertion into power outlets are known, as are systems comprising a charger and adapter(s), the adapters having assemblies that include a prong configuration that differs from that of an integral plug configuration of the charger. This allows for use of the charger in various countries/power outlets configured to accept prongs of plugs that differ in configuration from the integral plug configuration of the charger.

Examples of various plugs, such as rotatable plugs, foldable plugs or retractable plugs and in some cases, associated adaptor assemblies, are shown and described in U.S. Pat. Nos. 7,104,813, 7,481,660, 8,182,274, 9,385,548, 9,985,397, and 10,601,194, the content of each of which is hereby incorporated by reference in its entirety. In particular, some of these patents disclose various methods of securing the adaptor assemblies to the charger via particular elements and configurations of a charger and related adapter assemblies.

Moreover, chargers are typically and frequently subjected to movement from one outlet to the next and are typically packed along with other necessities during a user's travel. As such, it is imperative that chargers be provided with sufficient construction to withstand such frequent handling and the associated impact visited upon the charger by such constant use and rough handling. This may include dropping and/or bumping of the charger upon various surfaces, such as floors, tabletops, or walls, for example. Accordingly, it would be desirous that a charger be provisioned with supplemental protection to minimize and ideally eliminate damage from such impact and abuse.

Additionally, chargers typically resemble one another in general shape, color and size. This imparts a uniformity to their overall aesthetic appearance. Such similarity in general appearance may contribute to confusion of ownership, under particular circumstances, when multiple users are charging their respective devices in close proximity to one another. For example, such “communal charging” is commonly practiced in airport terminals, coffee shops and college campuses where a plurality of outlets are provided in close proximity to one another and for the express purpose of charging/running various portable electronic devices (chargers, mobile phones, computers and the like). It would be advantageous if a charger were provided with a proficient way by which a user may customize and personalize the appearance of their own charger in order to more easily differentiate and identify/recognize their chargers from other chargers and/or impart a user's personalized sense of style and/or color and/or aesthetics to the charger.

Therefore, there is a need for a charger and system that is not limited to having one plug prong configuration, but rather securely engages with at least one adapter assembly having a prong configuration that is different than an intrinsic prong configuration of the charger. There is a further need for a having a charger that has increased protection from damage due to mishandling and/or impact, while at the same time providing the possibility of customization/personalization in accordance with a particular end-user's aesthetic style and preference.

Various aspects of the charger and system disclosed herein addresses these and other needs, as discussed below.

### SUMMARY

Aspects of the present specification disclose a charger and a charging system comprising a charger disclosed herein. Besides a charger, a charger system disclosed herein can comprise one or more adaptor assemblies, one or more removeable covers, a power cord, or any combination thereof. A charger disclosed herein can comprises an integral plug that can adopt one of two plug positions. In the first position, an integral plug disclosed herein is extended outward and substantially perpendicular to the bottom of the charger. In this first plug configuration, a charger disclosed herein can use the integral plug to directly plug into a compatible electric outlet to charge a battery(s) and/or supply electrical power to a device. In the second position, an integral plug disclosed herein is positioned within the charger in a manner where the integral plug is flush with/to the bottom of the charger. In this second plug configuration, a charger disclosed herein can use the integral plug to reversibly and operationally engage an adaptor assembly disclosed herein. An integral plug disclosed herein can be in constant communication with at least one conductive strip, the at least one conductive strip being configured to engage the integral plug at a first conductive strip seat when the integral plug is in the first plug position or a second conductive strip seat when the integral plug is in the second plug position.

A charger disclosed herein can also comprises an adaptor mount. An adaptor mount disclosed herein is configured to operationally receive an adaptor assembly disclosed herein. An adaptor mount disclosed herein can comprise an adaptor mounting plug with a latch box dimensioned and sized to reversibly and operationally engage an adaptor assembly disclosed herein.

A charger disclosed herein can further include a charger housing and a circuit board housed therein. A charger housing comprises a charger housing top and charger housing bottom, a charger housing top disclosed herein being fixedly attached to the charger housing bottom. A circuit board disclosed herein connects to and communicates with the at least one conductive strip to establish electrical communication with an integral plug disclosed herein. A circuit board disclosed herein comprises a battery and a power port. A battery disclosed herein powers a circuit board disclosed herein, stores energy when a charger disclosed herein is plugged into an electrical outlet, and releases energy to a device when the device is operationally connected to a charger disclosed herein. A power port disclosed herein is configured to receive a plug of power cord disclosed herein.

A charger disclosed herein can further include a removeable cover dimensioned and sized to fit over and encase a charger housing top disclosed herein. A removeable cover disclosed herein can include on its outer surface a color, an ornamental design and/or indicia thereon, including user-selected indicia. Indicia includes, without limitation, one or any combination of letters, a design, a pattern, an image, a brand logo, a sports team logo or a company logo, for example. A removeable cover disclosed herein can be provided in a color that is different than the color and/or opacity of a charger housing top, a charger housing bottom, or both. A removeable cover disclosed herein can releasably engage a charger housing top via magnets and/or be a friction fit, for example, where a charger housing top disclosed herein further includes at least one charger magnet and a removeable cover disclosed herein further includes at least one cover magnet. In one aspect, when a removeable cover is fitted onto a charger housing top, the least one charger magnet becomes substantially aligned and in proximity with the at least one cover magnet, thereby providing an attractive magnetic force to enable releasable securing between the charger housing top and the removeable cover.

A charger system disclosed herein can comprise one or more additional removeable covers disclosed herein, each having on its outer surface a color, and/or an ornamental design and/or indicia thereon that differ from those provide on a removeable cover included with a charger disclosed herein and/or the other additional removeable covers. An additional removeable cover disclosed herein provides a user the ability to exchange one removeable cover for another.

A charger system disclosed herein can comprise one or more adaptor assemblies. An adapter assembly disclosed herein comprises a mounting base and an adaptor plug assembly. A mounting base disclosed herein is dimensioned and sized to releasably and operationally engage an adaptor mount of a charger disclosed herein. An adaptor plug assembly disclosed herein comprises an adaptor plug having at least one adaptor prong, the adaptor plug assembly having an electrical plug standard different than that of the integral plug. An adapter assembly disclosed herein comprises at least one adaptor conductive strip. An adaptor conductive strip disclosed herein includes a first end and a second end, the first end being connected to and in communication with the at least one adaptor prong and the second end capable of being in communication with an integral plug disclosed herein when the at least one adapter assembly is operationally engaged to the charger.

A charger system disclosed herein can comprise a power cord. A power cord disclosed herein includes a plug configured to operationally engage with the power port of a charger disclosed herein, a flexible cord, and an electrical plug configured to plug into any compatible electrotonic device, such as a mobile phone, laptop, tablet, headsets and the like.

Aspects of the present specification also disclose a kit. A kit disclosed herein can comprise a charger system disclosed herein, a charger disclosed herein, with or without removeable cover disclosed herein, one or more adapter assemblies disclosed herein, one or more removeable covers disclosed herein, a power cord disclosed herein, or any combination or number thereof.

Other objects, advantages and novel features of the invention will become more apparent from the following detailed description when taken in conjunction with the attached drawings.

### BRIEF DESCRIPTION OF DRAWINGS

The accompanying drawings, which are incorporated in and constitute a part of this specification, illustrate aspects of the disclosed subject matter in at least one of its exemplary embodiments, which are further defined in detail in the following description. Features, elements, and aspects of the disclosure are referenced by numerals with like numerals in different drawings representing the same, equivalent, or similar features, elements, or aspects, in accordance with one or more embodiments. The drawings are not necessarily to scale, emphasis instead being placed upon illustrating the principles herein described and provided by exemplary embodiments of the invention. In such drawings:

FIG. 1 is a rear, left side perspective view of components of an exemplary embodiment of a charger system in accordance with one aspect of present disclosure;

FIG. 2 is an exploded, rear, left side perspective view of exemplary components of an exemplary charger and an exemplary removeable cover provided in accordance with aspects of the instant disclosure;

FIG. 3 is an exploded, front, right side perspective view of exemplary components of an exemplary charger and an exemplary removeable cover provided in accordance with aspects of the instant disclosure;

FIG. 4 is a front left side perspective view of an exemplary charger and an exemplary removeable cover provided in accordance with aspects of the disclosure;

FIG. 5 is an exploded, front, left side perspective view of exemplary components of an exemplary charger housing bottom in accordance with aspects of the instant disclosure;

FIG. 6 is a front, bottom perspective view of an exemplary charger housing bottom provided in accordance with aspects of the disclosure;

FIG. 7 is a rear, left side perspective view of an exemplary securing cover of plug housing assembly in accordance with aspects of the disclosure;

FIG. 8 shows a close-up, rear, top perspective view of an exemplary adaptor mount in accordance with an aspect of the disclosure;

FIG. 9 is a close-up rear, bottom perspective view of an exemplary mount base according to one aspect of the disclosure;

FIG. 10A is an exploded, rear, left side perspective view of an exemplary adaptor assembly according to one aspect of the disclosure showing internal components of an Australian standard plug;

FIG. 10B is an exploded, rear, left side perspective view of an exemplary adaptor assembly according to one aspect of the disclosure showing internal components of a European Union standard plug;

FIG. 10C is an exploded, rear, left side perspective view of an exemplary adaptor assembly according to one aspect of the disclosure showing internal components of a United Kingdom standard plug;

FIG. 10D is an exploded, front, right side perspective view of an exemplary adaptor assembly according to one aspect of the disclosure showing internal components;

FIG. 11 is a rear, left side perspective view of an exemplary charger system shown prior to mounting of the exemplary adapter assembly to the exemplary charger;

FIG. 12 is a rear, left side perspective view of an exemplary charger system shown with the exemplary adapter assembly mounted to the exemplary charger;

FIG. 13 is a cross-sectional view of the charger from FIG. 1, taken along line 13-13;

FIG. 14 is a cross-sectional view of the charger system of FIG. 12, taken along line 14-14; and

FIG. 15 is a cross-sectional view of an exemplary charger system disclosed herein.

Listing of Reference Numbers Associated with Drawings

| Ref No. | Element |
|---|---|
| 10 | Charger System |
| 12 | Charger of charger system 10 |
| 14 | Adapter assembly of charger system 10 |
| 16 | Power cord of charger system 10 (optional) |
| 17 | Plug of power cord 16 |
| 18 | Flexible cord of power cord 16 |
| 20 | Charger housing of charger 12 |
| 30 | Charger housing top of charger housing 20 |
| 31 | Top of charger housing top 30 |
| 31′ | External surface of top 31 |
| 31″ | Internal surface of top 31 |
| 33 | First side of charger housing top 30 |
| 33′ | External surface of first side 33 |
| 33″ | Internal surface of first side 33 |
| 34 | Second side of charger housing top 30 |
| 34′ | External surface of second side 34 |
| 34″ | Internal surface of second side 34 |
| 35 | Third side of charger housing top 30 |
| 35′ | External surface of third side 35 |
| 35″ | Internal surface of third side 35 |
| 36 | Fourth side of charger housing top 30 |
| 36′ | External surface of fourth side 36 |
| 36″ | Internal surface of fourth side 36 |
| 37 | Notch of first side 33 |
| 37′ | Perimeter edge of notch 37 |
| 38 | Plug aperture of third side 35 |
| 40 | Internal chamber of charger housing top 30 |
| 41 | Perimeter edge of charger housing top 30 |
| 42 | First magnet seat of internal surface 31″ |
| 43 | Second magnet seat of internal surface 31″ |
| 44 | Third magnet seat of internal surface 31″ |
| 45 | First magnet of first magnet seat 42 |
| 46 | Second magnet of first magnet seat 43 |
| 47 | Third magnet of first magnet seat 44 |
| 48 | Fourth magnet |
| 50 | Charger housing bottom of charger housing 20 |
| 51 | External surface of charger housing bottom 50 |
| 52 | Internal surface of charger housing bottom 50 |
| 53 | First side of charger housing bottom 50 |
| 54 | Second side of charger housing bottom 50 |
| 55 | Third side of charger housing bottom 50 |
| 56 | Fourth side of charger housing bottom 50 |
| 60 | Plug housing assembly of charger housing bottom 50 |
| 61 | Perimeter of plug housing assembly 60 |
| 62 | Adaptor mount of plug housing assembly 60 |
| 64 | Adapter mounting slot of adaptor mount 63 |
| 65 | Back side of adaptor mounting slot 64 |
| 66 | First side of adaptor mounting slot 64 |
| 67 | Second side of adaptor mounting slot 64 |
| 68 | Third side of adaptor mounting slot 64 |
| 69 | Front opening of adaptor mounting slot 64 |
| 70 | Adaptor mounting plug of adaptor mount 63 |
| 72 | Front surface of adaptor mounting plug 70 |
| 73 | First side surface of adaptor mounting plug 70 |
| 74 | First groove of first surface 73 |
| 75 | First ridge of first surface 73 |
| 76 | Second side surface of adaptor mounting plug 70 |
| 77 | Second groove of second surface 76 |
| 78 | Second ridge of second surface 76 |
| 79 | Third side surface of adaptor mounting plug 70 |
| 80 | Latch box of third surface 79 |
| 81 | Channel of latch box 80 |
| 82 | First side of latch box 80 |
| 83 | Second side of latch box 80 |
| 84 | Engagement box of latch box 80 |
| 85 | Leading face of engagement box 84 |
| 86 | Bottom face of engagement box 84 |
| 87 | Trailing face of engagement box 84 |
| 90 | Plug assembly mount of plug housing assembly 60 |
| 91 | Conductive strip support of plug assembly support 90 |
| 92 | First conductive strip platform of conductive strip support 91 |
| 93 | First peg of first conductive strip platform 92 |
| 94 | Second conductive strip platform of conductive strip support 91 |
| 97 | First through hole of first conductive strip platform 92 |
| 95 | Second peg of second conductive strip platform 94 |
| 96 | Threaded blind hole of plug assembly support 90 |
| 98 | Second through hole of second conductive strip platform 94 |
| 100 | Integral plug support of plug assembly support 90 |
| 101 | First prong chamber of integral plug support 100 |
| 102 | First side of first prong chamber 101 |
| 103 | Second side of first prong chamber 101 |
| 104 | Third side of first prong chamber 101 |
| 105 | Fourth side of first prong chamber 101 |
| 106 | First outside yoke of first side 102 |
| 107 | First inside yoke of second side 103 |
| 108 | First prong port of third side 104 |
| 109 | First conductive projection slot of fourth side 105 |
| 111 | Second prong chamber of integral plug support 100 |
| 112 | First side of second prong chamber 111 |
| 113 | Second side of second prong chamber 111 |
| 114 | Third side of second prong chamber 111 |
| 115 | Fourth side of second prong chamber 111 |
| 116 | Second outside yoke of first side 112 |
| 117 | Second inside yoke of second side 113 |
| 118 | Second prong port of third side 114 |
| 119 | Second conductive projection slot of fourth side 115 |
| 120 | Axle stop of integral plug support 100 |
| 121 | Axle chamber of integral plug support 100 |
| 122 | Though hole of axle stop 120 |
| 130 | Integral plug assembly of plug housing assembly 60 |
| 132 | Integral plug of integral plug assembly 130 |
| 134 | First prong of integral plug 132 |
| 135 | Second prong of integral plug 132 |
| 136 | First conductive projection of axle 140 |
| 137 | Second conductive projection of axle 140 |
| 140 | Axle of integral plug 132 |
| 142 | First outside pivot of axle 140 |
| 144 | First inside pivot of axle 140 |
| 146 | Second outside pivot of axle 140 |
| 148 | Second inside pivot of axle 140 |
| 150 | Conductive strip assembly of integral plug assembly 130 |
| 152 | First conductive strip of conductive strip assembly 150 |
| 153 | Elongated stem portion of first conductive strip 152 |
| 154 | Short arm portion of first conductive strip 152 |
| 155 | First seat of elongated stem portion 153 |
| 156 | Second seat of short arm portion 154 |
| 157 | First circuit board connector of elongated stem portion 153 |
| 158 | Tab of first circuit board connector 157 |
| 159 | First peg through holes of elongated stem portion 153 |
| 162 | Second conductive strip of conductive strip assembly 150 |
| 163 | Elongated stem portion of second conductive strip 162 |
| 164 | Short arm portion of second conductive strip 162 |
| 165 | First seat of elongated stem portion 163 |
| 166 | Second seat of short arm portion 164 |
| 167 | Second circuit board connector of elongated stem portion 163 |
| 168 | Tab of second circuit board connector 167 |
| 169 | Second peg through holes of elongated stem portion 163 |
| 170 | Securing cover of plug housing assembly 60 |
| 171 | External surface of securing cover 170 |
| 172 | Internal surface of securing cover 170 |
| 173 | First peg through hole of securing cover 170 |
| 175 | Second peg through hole of securing cover 170 |
| 176 | Fastener through hole of securing cover 170 |
| 177 | Fastener of securing cover 170 |
| 178 | First securing tab of securing cover 170 |
| 179 | Second securing tab of securing cover 170 |
| 180 | Third securing tab of securing cover 170 |
| 181 | First prong chamber cover of internal surface 172 |
| 186 | First outside yoke cover of first prong chamber 181 |
| 187 | First axle cover of first prong chamber 181 |
| 191 | Second prong chamber cover of internal surface 172 |
| 196 | Second outside yoke cover of second prong chamber 191 |
| 197 | Second axle cover of second prong chamber 191 |
| 200 | Circuit board of charger 12 |
| 202 | First surface of circuit board 200 |
| 204 | Second surface of circuit board 200 |
| 206 | Battery of circuit board 200 |
| 208 | Power port of circuit board 200 |
| 210 | Heat shield of circuit board 200 |
| 212 | Electromagnetic shield of circuit board 200 |
| 220 | Ferrite shield of charger 12 |
| 222 | Adhesive tape of ferrite shield 220 |
| 230 | Removeable cover of charger system 10 |
| 231 | Top of removeable cover 230 |
| 231′ | External surface of top 231 |
| 231″ | Internal surface of top 231 |
| 233 | First side of removeable cover 230 |
| 233′ | External surface of first side 233 |
| 233″ | Internal surface of first side 233 |
| 234 | Second side of removeable cover 230 |
| 234′ | External surface of second side 234 |
| 234″ | Internal surface of second side 234 |
| 235 | Third side of removeable cover 230 |
| 235′ | External surface of third side 235 |
| 235″ | Internal surface of third side 235 |
| 236 | Fourth side of removeable cover 230 |
| 236′ | External surface of fourth side 236 |
| 236″ | Internal surface of fourth side 236 |
| 237 | Notch of first side 233 |
| 237′ | Perimeter of notch 237 |
| 238 | Plug aperture of third side 235 |
| 240 | Internal chamber of removeable cover 230 |
| 241 | Perimeter edge of removeable cover 230 |
| 242 | First magnet seat of internal surface 231″ |
| 243 | Second magnet seat of internal surface 231″ |
| 244 | Third magnet seat of internal surface 231″ |
| 245 | First magnet of first magnet seat 242 |
| 246 | Second magnet of first magnet seat 243 |
| 247 | Third magnet of first magnet seat 244 |
| 248 | Fourth magnet |
| 250 | Housing of adaptor assembly 14 |
| 252 | Protective pad of removeable cover 230 |
| 254 | Adhesive tape of protective pad 248 |
| 256 | Adhesive tape of magnets 45, 46, 47, 48, 245, 246, 247, 248 |
| 260 | Mounting base of adapter assembly 14 |
| 262 | Body of mounting base 260 |
| 264 | Front side of body 262 |
| 265 | Back side of body 262 |
| 266 | First side of body 262 |
| 267 | Second side of body 262 |
| 268 | Third side of body 262 |
| 270 | First prong channel of back side 265 |
| 272 | Second prong channel of back side 265 |
| 273 | Latch lock assembly of back side 265 |
| 274 | Latch lock slot of latch lock assembly 273 |
| 275 | Back side of latch lock slot 274 |
| 276 | First side of latch lock slot 274 |
| 276′ | Ridge of first side 276 |
| 277 | Second side of latch lock slot 274 |
| 277′ | Ridge of second side 277 |
| 278 | Third side of latch lock slot 274 |
| 279 | Front opening of latch lock slot 274 |
| 280 | Latch lock of latch lock assembly 273 |
| 282 | First rail of latch lock 280 |
| 283 | Second rail of latch lock 280 |
| 284 | Bolt of latch lock 280 |
| 285 | Leading edge of bolt 284 |
| 286 | Top edge of bolt 284 |
| 287 | Trailing edge of bolt 284 |
| 290 | Adaptor plug assembly of adapter assembly 14 |
| 292 | Electrical plug (Australian standard) of electrical plug assembly 290 |
| 293 | First adaptor prong of electrical prong 292 |
| 293′ | Internal portion of first adaptor prong 293 |
| 294 | Connector for first prong 293 |
| 295 | Second adaptor prong of electrical prong 292 |
| 295′ | Internal portion of second adaptor prong 295 |
| 296 | Connector for second prong 295 |
| 302 | Electrical plug (European Union standard) of electrical plug assembly 290 |
| 303 | First adaptor prong of electrical prong 302 |
| 303′ | Internal portion of first adaptor prong 303 |
| 304 | Connector for first prong 303 |
| 305 | Second adaptor prong of electrical prong 302 |
| 305′ | Internal portion of second adaptor prong 305 |
| 306 | Connector for second prong 305 |
| 312 | Electrical plug (United Kingdom standard) of electrical plug assembly 290 |
| 313 | First adaptor prong of electrical prong 312 |
| 313′ | Internal portion of first adaptor prong 313 |
| 314 | Connector for first prong 313 |
| 315 | Second adaptor prong of electrical prong 312 |
| 315′ | Internal portion of second adaptor prong 315 |
| 316 | Connector for second prong 315 |
| 317 | Third adaptor prong of electrical prong 312 |
| 317′ | Internal portion of third adaptor prong 317 |
| 318 | Connector for third prong 317 |
| 320 | Top adaptor housing of adaptor assembly 14 |
| 321 | Bottom of top adaptor housing 320 |
| 321′ | External surface of bottom 321 |
| 321″ | Internal surface of bottom 321 |
| 322 | Side of top adaptor housing 320 |
| 322′ | External surface of side 322 |
| 322″ | Internal surface of side 322 |
| 323 | First AU electrical plug port of top adaptor housing 320 |
| 324 | Second AU electrical plug port of top adaptor housing 320 |
| 325 | First EU electrical plug port of top adaptor housing 320 |
| 327 | First UK electrical plug port of top adaptor housing 320 |
| 328 | Second UK electrical plug port of top adaptor housing 320 |
| 334 | Rabbet of internal side 322″ |
| 335 | Ridges of rabbet 324 |
| 336 | Grooves of rabbet 324 |
| 337 | Securing posts of internal surface 321″ |
| 338 | Internal chamber of adaptor assembly 14 |
| 340 | Bottom adaptor housing of adaptor assembly 14 |
| 341 | Top plate of bottom adaptor 340 |
| 341′ | External surface of top plate 341 |
| 341″ | Internal surface of top plate 341 |
| 342 | Side of bottom adaptor 340 |
| 342′ | External surface of side 342 |
| 342″ | Internal surface of side 342 |
| 343 | Protection pad of bottom adaptor housing 340 |
| 344 | Rabbet of external surface 342′ |
| 345 | Ridges of rabbet 344 |
| 346 | Grooves of rabbet 344 |
| 347 | Housing securing pins of internal surface 341″ |
| 348 | Conductive strip securing pins of internal surface 341″ |
| 349 | Conductive strip securing ridges of internal surface 341″ |
| 350 | First adaptor conductive strip of electrical plug assembly 290 |
| 352 | Body of first adaptor conductive strip 350 |
| 353 | First end of body 352 |
| 354 | Second end of body 352 |
| 356 | Prong tab of first end 353 |
| 358 | Integral plug tab of second end 354 |
| 359 | Through hole of body 352 |
| 360 | Second adaptor conductive strip of electrical plug assembly 290 |
| 362 | Body of second adaptor conductive strip 360 |
| 363 | First end of body 362 |
| 364 | Second end of body 362 |
| 366 | Prong tab of first end 363 |
| 368 | Integral plug tab of second end 364 |
| 369 | Through hole of body 362 |

### DETAILED DESCRIPTION

The present disclosure provides and describes a charging system comprising a charger, at least one adaptor assembly and an optional power cord that, by its disclosed features, is compatible for use with different adapter assemblies having adaptor plugs with electrical plug standards different than that of an integral plug present in the charger. A charger disclosed herein may provide power directly to an electronic device by plugging into a power outlet that is configured to accept the electrical standard of an integral plug of the charger. Such power can operate a device by concurrently supplying power directly to the electronic device and/or charging one or more internal batteries which can store power and supply power to the electronic device for operation at a later date. The at least one adapter assembly has an electrical plug standard that is different than that of the integral plug of a charger disclosed herein. Adapter assemblies may have any type of electrical plug standard (e.g. Type A, B, C, D, E, F, G, H, I, J, K etc.) as known in the art.

The disclosed chargers and adapter assemblies provide a secure engagement mechanism configured to operatively associate and secure the charger to an adapter assembly. When utilizing a charger and associated adapter assembly, it is desirable that the engagement of one with the other is sufficiently robust and secure enough such that engagement/disengagement of the charger with the adapter assembly occurs when desired and intended by a user, such as when a user intentionally fits a selected adapter onto or removes it from the charger, rather than when removing the charger and adapter from a power outlet. If the releasable association of the charger to the adapter is not sufficiently robust, then upon attempted removal of adapter with an associated charger from an outlet may result in unintended separation of the adapter (plugged into the outlet) from the charger which may result in the adapter assembly remaining in the power outlet while the charger is in hand.

In other aspects, the disclosed chargers include a conductive strip shaped and configured to provide robust and positive communication with an integral plug and a removeable cover sized and configured to releasably encase the charger housing top to provide end-user selection/customizability as well as enhanced protection to the charger and system herein disclosed.

The detailed description set forth below in connection with the appended drawings is intended as a description of the concepts and teachings of the instant disclosure and is not meant to be limiting. Exemplary charger and system configurations, geometries, and associated methods of use, as well kits that include one or more chargers and/or systems provided in accordance with the teachings of the present disclosure are herein disclosed. Thus, the invention is not limited to only such exemplary teachings and/or configurations. Particular embodiments of the charger and system herein disclosed may be utilized with various personal devices and cords, such as, but not limited to, laptop computers, tablets, mobile phones, smart watches, fitness trackers and the like. It is further understood that the use of relational terms, such as but not limited to, first, second, distal, proximal, and the like are used solely to distinguish one from another entity without necessarily requiring or implying any actual such relationship or order between such entities.

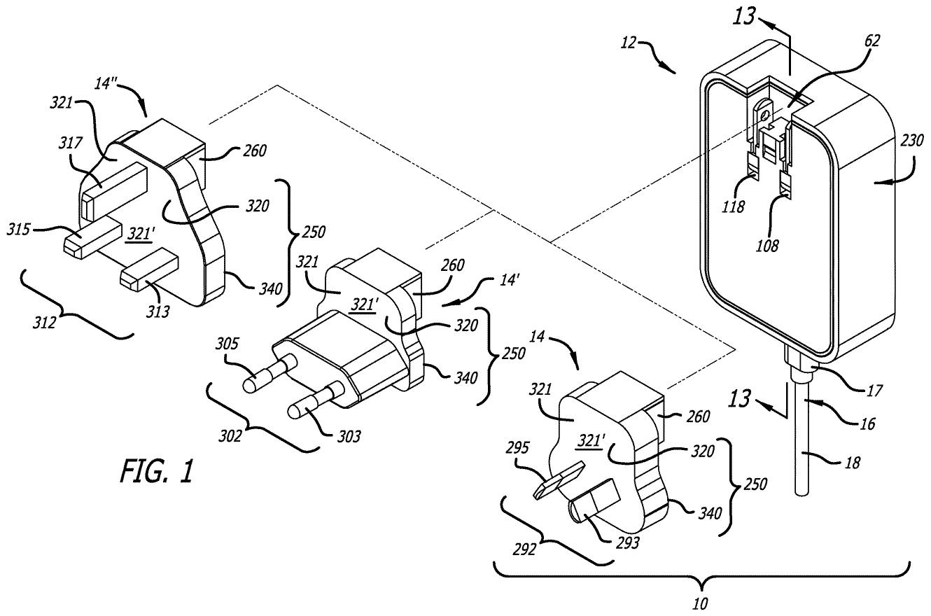

An exemplary charger system disclosed herein, which can also be referred to as a or charger kit, comprises a charger, at least one adaptor assembly, optionally at least one removeable cover, and optionally a power cord, the charger system configured for use with an electronic device for powering and/or charging electronic devices. In some embodiments, and as shown in FIG. 1, a charger system 10 comprises a charger 12, three different adaptor assemblies 14, 14′, 14″, a removeable cover 230, and a power cord 16. Charger 12 can be utilized on its own and be plugged directly into a power outlet that is configured to accept the electrical standard of an integral plug present in charger 12, which in the exemplary embodiment of FIG. 1 is a U.S./Canadian electrical plug standard. Exemplary adapter assemblies 14, 14′, and 14″ can have electrical plug standards for use in outlets typically found in Australia, the European Union, and the United Kingdom, respectively. While FIG. 1 depicts three adapter assemblies (14, 14′, and 14′), each having an electrical plug standard different from each other and the integral plug, one, two, three, four or any number of desired adapter assemblies may be provided having any one, or combination of, electrical plug standards in accordance with a desired charger system 10. A power cord 16 can be provided and may be in either releasable or fixed engagement with charger 12. In some embodiments, power cord 16 is configured to releasable engage charger 12 and comprises a plug 17 configured to operationally engage with a power port of charger 12, a flexible cord 18, and an device plug (not shown) configured to plug into any compatible electrotonic device, such as a mobile phone, laptop, tablet, headsets and the like, that is configured to accept the device plug of power cord 16.

A charger disclosed herein comprises a charger housing, a circuit board, and a removable cover. A charger housing disclosed herein can comprises two components, a charger housing top and a charger housing bottom. A charger housing top disclosed herein can comprises a top and at least one side wall extending perpendicular from the top to define an internal chamber thereby creating an external surface and an internal surface. As such, a charger housing top disclosed herein has an external surface and an internal surface opposite the external surface. Likewise, the at least one side wall has an external surface and an internal surface opposite the external surface. A charger housing top disclosed herein can be any shape with the proviso that the shape is configured to properly function as a charging device, e.g., being able to plug into an electrical outlet, receive an adaptor assembly disclosed herein, and plug into an electrical device. Non-limiting examples of a perimeter shape of a charger housing top disclosed herein include a convex polygonal shape, such as, e.g., a triangular shape, a square shape, a rectangular shape, a pentagonal shape, a hexagonal shape, a heptagonal shape or an octagonal shape; a star polygonal shape, such as, e.g., a pentagrammic shape, a heptagramic shape, an octagramic shape or decagramic shape; or a closed curved shape such as, e.g., a circular shape, an ovoidal shape, an oblong shape, or any other closed curved shape. In some embodiments, a charger housing top disclosed herein is rectangular in shape, square in shape, circular in shape, or oval in shape.

The at least one side wall comprises a notch dimensioned and sized to receive a plug housing assembly disclosed herein and a plug aperture, a through hole configured to allow passage of a plug of a power cord disclosed herein which enables insertion of the plug into a power port of a circuit board disclosed herein. The internal surface of a charger housing top disclosed herein may comprise at least one magnet seat configured to house a magnet. Additionally, for example, the internal surface of a removeable cover disclosed herein can comprise one magnet seat with associated magnet, two magnet seats with associated magnets, three magnet seats with associated magnets, four magnet seats with associated magnets, or five magnet seats with associated magnets.

A charger housing bottom disclosed herein has an external surface and an internal surface and at least one side. The at least one side is configured to be received by internal chamber of a charger housing top disclosed herein. The at least one side comprises a plug housing assembly. A plug housing assembly comprises a plug assembly mount, an integral plug assembly, and a securing cover.

A removeable outer cover disclosed herein is configured to cover a charger housing disclosed herein. In some embodiments, a removeable outer cover disclosed herein covers at least a top of a charger housing disclosed herein. In some embodiments, a removeable outer cover disclosed herein covers a top and at least one side wall extending perpendicular from the top of a charger housing disclosed herein. A removeable cover disclosed herein can comprises a top and at least one side wall extending perpendicular from the top to define an internal chamber thereby creating an external surface and an internal surface. As such, a top disclosed herein has an external surface and an internal surface opposite the external surface. Likewise, the at least one side wall has an external surface and an internal surface opposite the external surface. A removeable outer cover top disclosed herein can be any shape with the proviso that the shape is configured to properly engage with a charger housing disclosed herein. Non-limiting examples of a perimeter shape of a removeable outer cover top disclosed herein include a convex polygonal shape, such as, e.g., a triangular shape, a square shape, a rectangular shape, a pentagonal shape, a hexagonal shape, a heptagonal shape or an octagonal shape; a star polygonal shape, such as, e.g., a pentagrammic shape, a heptagramic shape, an octagramic shape or decagramic shape; or a closed curved shape such as, e.g., a circular shape, an ovoidal shape, an oblong shape, or any other closed curved shape. In some embodiments, a removeable outer cover top disclosed herein is rectangular in shape, square in shape, circular in shape, or oval in shape.

The at least one side wall comprises a notch dimensioned and sized to follow the contours of a plug housing assembly disclosed herein and a plug aperture, a through hole configured to allow passage of a plug of a power cord disclosed herein which enables insertion of the plug into a power port of a circuit board disclosed herein. The internal surface of a removeable cover disclosed herein comprises at least one magnet seat configured to house a magnet. For example, the internal surface of a removeable cover disclosed herein can comprise one magnet seat with associated magnet, two magnet seats with associated magnets, three magnet seats with associated magnets, four magnet seats with associated magnets, or five magnet seats with associated magnets. The at least one magnet of a removeable cover disclosed herein is arranged such that opposite magnetic poles of a substantially superimposed at least one magnet of a charger housing disclosed herein are pointed toward and attract each other, to provide releasable engagement between charger housing disclosed herein and a removable cover disclosed herein. As such, the removable cover can be pulled off of the charger housing while maintaining fixed engagement of charger housing top to charger housing bottom.

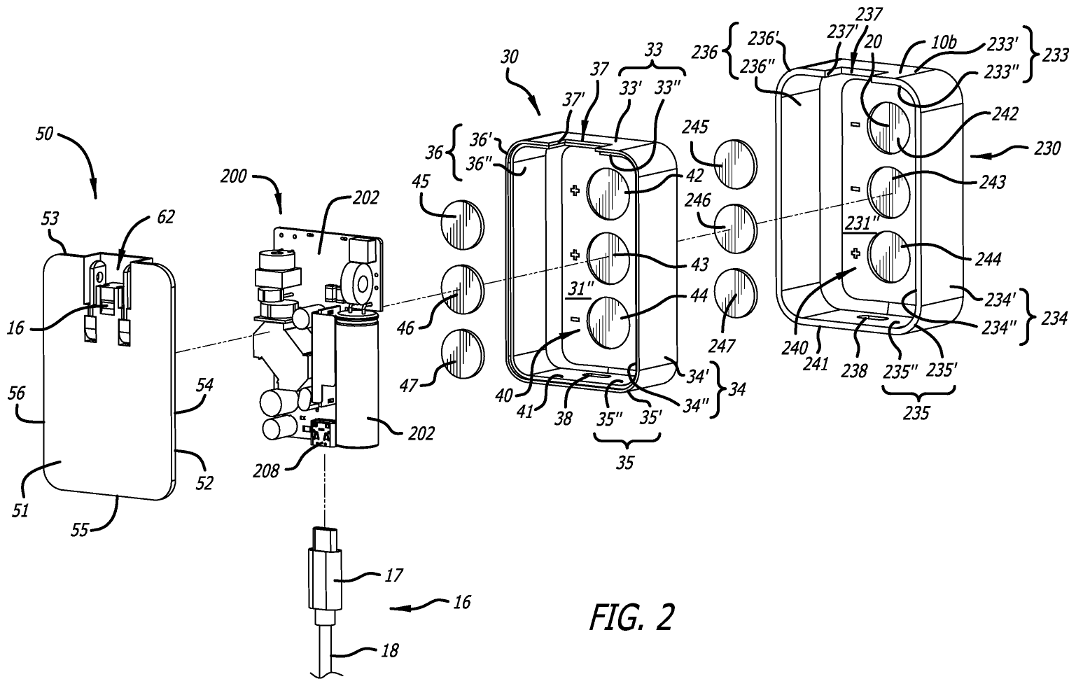

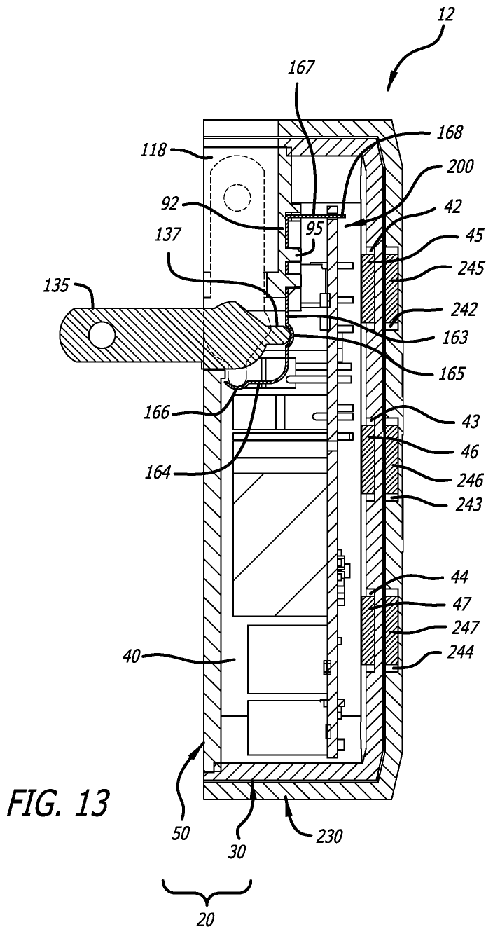

For example, in some embodiments, and as shown in FIGS. 2 & 3, charger 12 comprises a charger housing 20, a circuit board 200, and a removeable outer cover 230. Charger housing 20 comprises charger housing top 30 and charger housing bottom 50 (as also shown in FIGS. 13-15 for example).

In some embodiments, and referring to FIGS. 2 & 4, charger housing top 30 includes a top 31, a first side wall 33, a second side wall 34, a third side wall 35, and a fourth side wall 36, with first, second, third and fourth side walls 33, 34, 35, 36 extending perpendicular from top 31, thereby defining a 4-sided internal chamber 40 with a perimeter edge 41. Perimeter edge 41 includes a groove configured to receive a charger housing bottom disclosed herein. First side wall 33 is opposite to third side wall 35 and first side wall 33 is generally parallel to third side wall 35. Similarly, second side wall 34 is opposite to fourth side wall 36 and second side wall 34 is generally parallel to fourth side wall 36. Second and fourth side walls 34, 36 span between first and third side walls 33, 35 and are substantially perpendicular to first and third side walls 33, 35. Top 31 has an external surface 31′ and an internal surface 31″ opposite the external surface 31′. Likewise, first side wall 33 has an external surface 33′ and an internal surface 33″ opposite the external surface 33′, second side wall 34 has an external surface 34′ and an internal surface 34″ opposite the external surface 34′, third side wall 35 has an external surface 35′ and an internal surface 35″ opposite the external surface 35′, and fourth side wall 36 has an external surface 36′ and an internal surface 36″ opposite the external surface 36′.

Referring to FIG. 2, first side wall 33 includes a notch 37 having a perimeter 37′ dimensioned and sized to receive a plug housing assembly disclosed herein and provide clear access of a mounting base of an adapter assembly disclosed herein into and out of an adaptor mount disclosed herein of charger 12. Third side wall 35 includes a plug aperture 38, a through hole configured to allow passage of a plug of power cord 16 which enables insertion of the plug into a power port of a circuit board disclosed herein. In some embodiments, and referring to FIG. 2, internal surface 31″ of top 31 of charger housing top 30 comprises a first magnet seat 42, a second magnet seat 43, and a third magnet seat 44, each configured to house a magnet 45, 46, 47, respectively. Magnets 45, 45, 47 can be fitted into first, second, and third magnet seats 42, 43, 44 via a friction fit and/or by utilizing an adhesive, such as, e.g., a glue or a tape, to secure magnets 45, 46, 47 to first, second, and third magnet seats 42, 43, 44. First, second, and third magnet seats 42, 43, 44 are configured and spaced apart so that their respective magnets 45, 46, 47 operationally engage with one or more magnets located at a removable outer cover 230 disclosed herein.

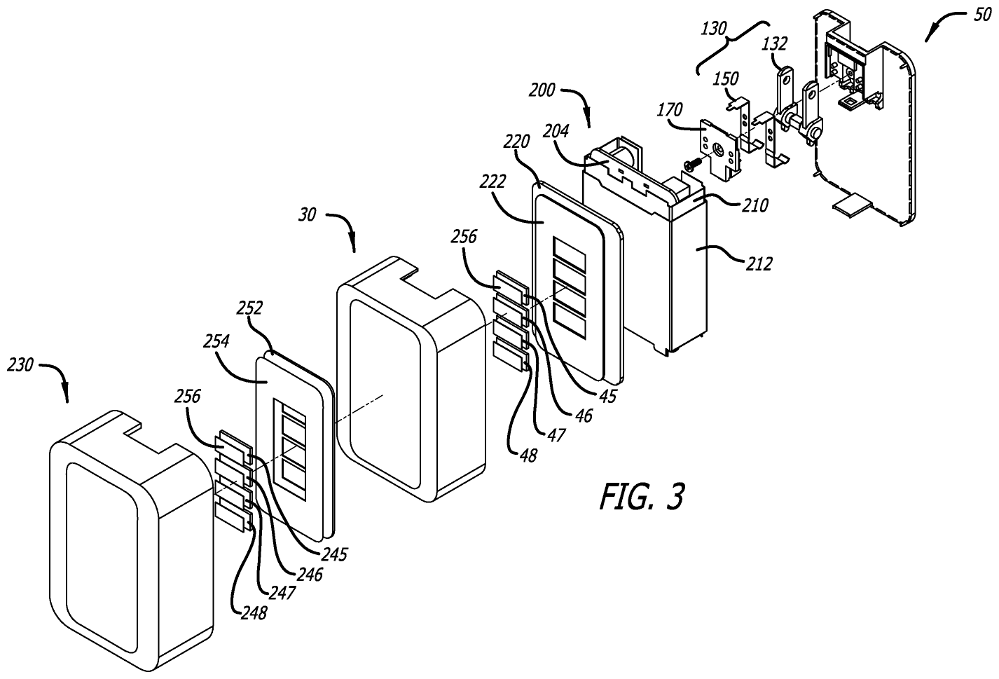

In some embodiments, and referring to FIG. 3, internal surface 31″ of top 31 of charger housing top 30 comprises a first, a second, a third, and a fourth magnet seats configured to receive magnets 45, 46, 47, 48. Magnets 45, 45, 47, 48 can be fitted into the first, second, third, and fourth magnet seats located in internal surface 31″ of top 31 via a friction fit and/or by utilizing an adhesive, such as, e.g., a glue or a tape, to secure magnets 45, 46, 47, 48 to the first, second, third, and fourth magnet seats. In some embodiments, and referring to FIG. 3, an adhesive tape 256 is used to secure magnets 45, 45, 47, 48 to internal surface 31″ magnets 45, 45, 47, 48 of charger housing top 30. First, second, third, fourth magnet seats are configured and spaced apart so that their respective magnets 45, 46, 47, 48 operationally engage with one or more magnets located at a removable outer cover 230 disclosed herein.

A charger housing bottom 50 disclosed herein is configured to hold and contain various exemplary components disclosed herein including an integral plug assembly disclosed herein and a circuit board disclosed herein. In some embodiments, and referring to FIGS. 2 & 5, charger housing bottom 50 includes an external surface 51, an internal surface 52, a first side 53, a second side 54, a third side 55, and a fourth side 56. First side 53 is opposite to third side 55 and first side 53 is generally parallel to third side 55. Similarly, second side 54 is opposite to fourth side 56 and second side 54 is generally parallel to fourth side 56. Second and fourth sides 54, 56 span between first and third sides 53, 55 and are substantially perpendicular to first and third sides 53, 55. The dimensions of charger housing bottom 50 are configured to insert within charger housing top 30 to form a tight fit with first, second, third, and fourth sides 53, 54, 55, 56 abutting first, second, third, and fourth internal surfaces 33″, 34″, 35″, 36″ in close proximity to perimeter edge 41 in a manner that closes internal chamber 40 of charger housing top 30 from the outside environment. Such a fit can be achieved by perimeter slots and rails and/or tabs and slots, adhesives and the like.

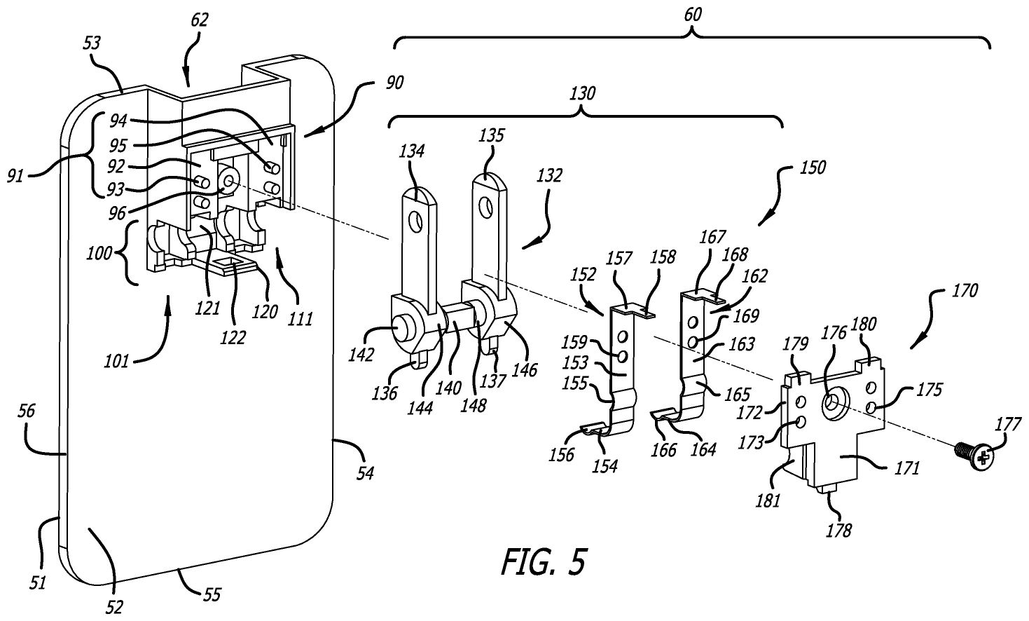

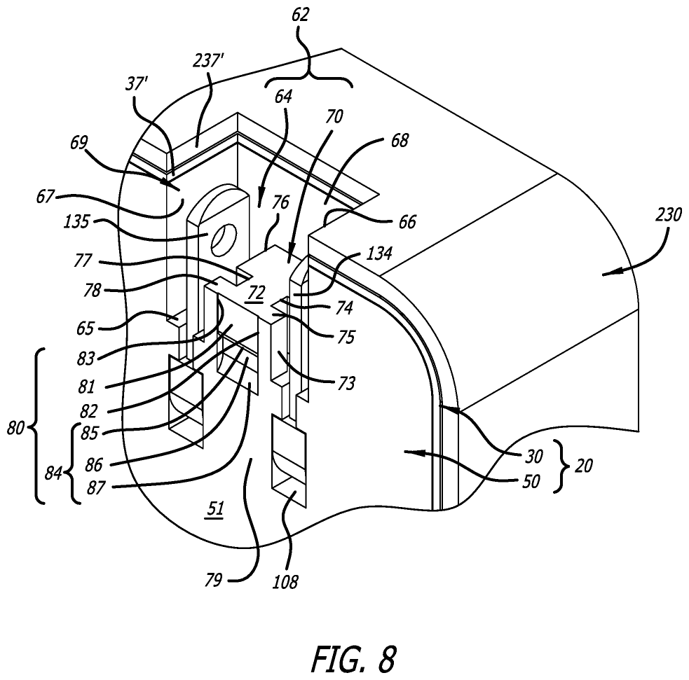

In some embodiments, and referring to FIG. 5, charger housing bottom 50 includes a plug housing assembly 60 located at first side 53. Plug housing assembly 60 comprises an adaptor mount 62, a plug assembly mount 90, an integral plug assembly 130 and a securing cover 170. Plug housing assembly 60 comprises elements located on external surface 51 and internal surface 52 of charger housing bottom 50. With respect to external features, plug housing assembly 60 includes an adaptor mount 62 configured to receive an adaptor assembly disclosed herein. In some embodiments, and referring to FIGS. 8 & 11, an adaptor mount 62 comprises an adaptor mounting slot 64 and an adaptor mounting plug 70.

Referring to FIG. 8, adaptor mounting slot 64 comprises a channel defined by a back side 65, a first side 66, a second side 67, a third side 68, and a front opening 69 (not shown). First side 66 is opposite to second side 67 with third side 68 spanning between first side 66 and second side 67. First side 66 is generally parallel to second side 67, with third side 68 being substantially perpendicular to the two. First, second, and third sides 66, 67, 68 form three-sided, U-shaped channel having a closed end defined by back 65 and an open end defining front opening 69. The dimensions of the three-sided U-shaped channel thus formed are configured to insert and releasably engage a mounting base of an adaptor assembly disclosed herein.

Still referring now to FIG. 8, adaptor mount 62 also comprises an adaptor mounting plug 70 is located on back side 65 and a portion of second side 67 of adaptor mounting slot 64. Adaptor mounting plug 70 is configured to releasably engage and secure an adaptor mounting base of an adaptor assembly disclosed herein to charger 12. Adaptor mounting plug 70 protrudes perpendicularly from back side 65 in a direction generally parallel to first and second sides 66, 67 and includes a front surface 72, a first side surface 73 (not shown), a second side surface 76, and a third side surface 79. Third side surface 79 is contiguous with and is an extension of external surface 51 of charger housing bottom 50 and comprises a latch box 80. Latch box 80 comprises a channel 81 having a first side 82 and a second side 83 and ending in an engagement box 84. Engagement box 84 is configured to receive and hold a bolt of a latch lock disclosed herein. Engagement box 84 can be of any geometrical shape as long as engagement box 84 robustly, releasably and complimentarily engages with the external geometry of a bolt of a latch lock disclosed herein. In some embodiments, engagement box 84 comprises a three-sided recess that includes a leading face 85, a bottom face 86, and a trailing face 87 and configured to operationally receive a latch lock of an adaptor assembly disclosed herein.

Still referring to FIG. 8, first and second side surfaces 73, 76 of adaptor mounting plug 70 extend perpendicularly from third side surface 79 until each join third side 68 of adaptor mounting slot 64. First side surface 73 contains a first groove 74 and second side surface 76 contain a second groove 77. First and second grooves 74, 77 extend the length of first and second side surfaces 73, 76 respectively and each in a direction generally parallel to third side surface 79. First and second grooves 74, 77 form first and second ridges 75, 78 located on first and second side surfaces 73, 76 respectively. As discussed below, first and second grooves 74, 77, are sized and dimensioned to operationally receive ridges present in a latch lock slot of a latch lock assembly disclosed herein to provide a secure and stable seating of an adaptor assembly disclosed herein operationally engaged to charger 12.

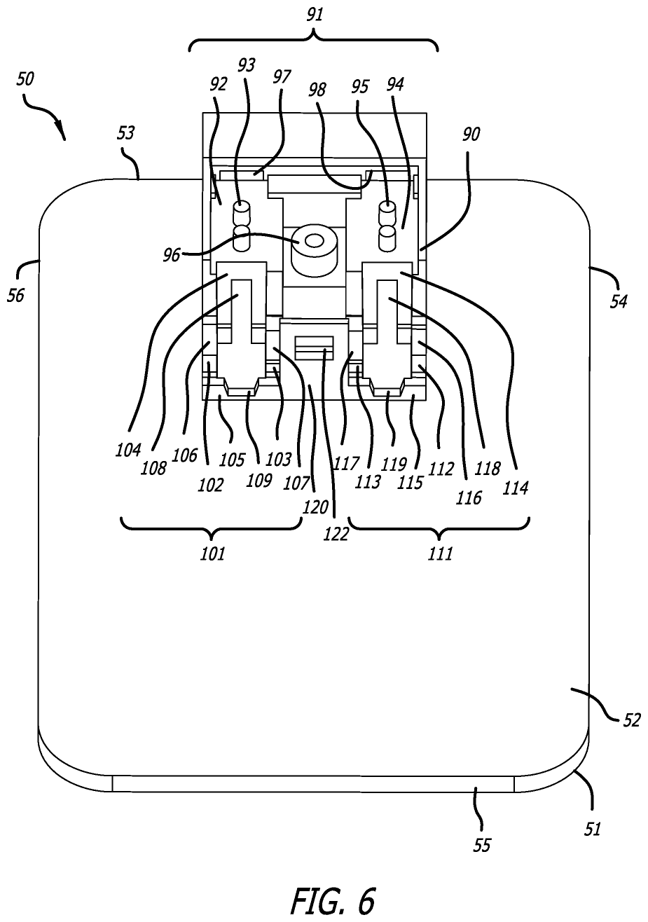

Referring now to FIGS. 5 and 6, internal features of plug housing assembly 60 comprise a plug assembly support 90, an integral plug assembly 130, and a securing cover 170. Plug assembly support 90 is configured to operationally hold and secure integral plug assembly 130 to plug housing assembly 60 and enable integral plug assembly 130 to correctly operate. Plug assembly support 90 comprises a conductive strip support 91, an integral plug support 100, and a threaded blind hole 96. Conductive strip support 91 is configured to operationally hold and secure a conductive strip assembly disclosed herein. In some embodiments, as shown in FIG. 5, conductive strip support 91 comprises a first conductive strip platform 92 having a through hole 97 and including one or more first pegs 93 and a second conductive strip platform 94 having a through hole 98 and including one or more second pegs 95. One or more pegs 93 are used to mount a first conductive strip disclosed herein and one or more pegs 95 are used to mount a second conductive strip disclosed herein. Threaded blind hole 96 is configured to receive a threaded fastener used to secure a securing cover disclosed herein.

Integral plug support 100 is configured to operationally hold and secure an integral plug assembly disclosed herein. In some embodiments, as shown in FIGS. 5 & 6, integral plug support 100 comprises a four-sided first prong chamber 101 including a first side 102 including a first outside yoke 106, a second side 103 including a first inside yoke 107, a four-sided second prong chamber 111 including a first side 112 including a second outside yoke 116, a second side 113 including a second inside yoke 117, and an axle chamber 121, a space bounded and comprising an axle stop 120. First side 102 is spaced apart and is generally parallel to second side 103 of first prong chamber 101 which is further defined by a third side 104 and a fourth side 105. Third and fourth sides 104, 105 are oppositely spaced apart and substantially perpendicular to first and second sides 102, 103 forming a four-sided structure. Third side 104 includes a first prong channel 108 (see FIG. 8) and fourth side 105 includes a first conductive projection slot 109. Similarly, first side 112 is spaced apart and is generally parallel to second side 113 of second prong chamber 111 which is further defined by a third side 114 and a fourth side 115. Third and fourth sides 114, 115 are oppositely spaced apart and substantially perpendicular to first and second sides 112, 113 forming a four-sided structure. Third side 114 includes a second prong channel 118 (see FIG. 8) and fourth side 115 includes a second conductive projection slot 119. First prong chamber 101 is spaced apart from second prong chamber 111 in a manner that allows A) the inside pivots of an integral plug disclosed herein to properly sit within first and second inside yokes 107, 117; B) the outside pivots of an integral plug disclosed herein to properly sit within first and second outside yokes 106, 116; and C) the prongs of an integral plug to operationally sit within first and second prong chambers 101, 111 in a manner that allows the prongs to moveably operate within first and second prong channels 108, 118.

Referring to FIGS. 5 & 6, axle chamber 121 is positioned in between first prong chamber 101 and second prong chamber 111 and is configured to allow an axle of an integral plug disclosed herein to properly sit within integral plug support 100 as disclosed herein and further hold and secure the integral plug. Axle stop 120 defines a third side of axle chamber 121 with a fourth side being defined by a portion of plug assembly mount 90. Thus, second side 103 of first prong chamber 101 is opposite to second side 113 of second prong chamber 111 and second side 103 is generally parallel to second side 113. Similarly, axle stop 120 is opposite to portion of plug assembly mount 90 and axle stop 120 is generally parallel to portion of plug assembly mount 90. Second and axle stop 120 and portion of plug assembly mount 90 span between second sides 103, 113 and are substantially perpendicular to second sides 103, 113. Axle stop 120 comprises a through hole 122. Through hole 122 is configured to receive and hold a tab from a securing cover disclosed herein which facilitates proper orientation of the securing cover during assembly.

As shown in FIG. 5, integral plug assembly 130 comprises an integral plug 132 and a conductive strip assembly 150. Integral plug 132 comprises a first prong 134 and a second prong 135, and an axle 140, with axle 140 positioned in between first prong 134 and second prong 135. First and second prongs 134, 135 are each oriented perpendicular to axle 140 and in the same direction. A first conductive projection 136 and a second conductive projection 137 arise perpendicular from axle 140 in a direction opposite to first and second prongs 134, 135. Axle 140 includes a first outside pivot 142, a first inside pivot 144, a second outside pivot 146, and a second inside pivot 148. First outside pivot 142 and first inside pivot 144 are positioned adjacent to first prong 134, with first outside pivot 142 having an outside flanking position relative to first prong 134 and first inside pivot 144 having an inside flanking position relative to first prong 134. Similarly second outside pivot 146 and second inside pivot 148 are positioned adjacent to second prong 135, with second outside pivot 146 having an outside flanking position relative to second prong 135 and second inside pivot 148 having an inside flanking position relative to second prong 135. As illustrated in FIG. 5, the linear order of these structures are first outside pivot 142, first prong 134, first inside pivot 144, axle 140, second inside pivot 148, second prong 135 and second outside pivot 146. Although the described integral plug assembly 130 been exemplified using an integral plug based on the United States of America electrical plug standard, integral plug assembly 130 can be modified to include an integral plug based on a different electrical plug standard, such as, e.g., an electrical plug based on the Australian standard, an electrical plug based on the European Union standard, or an electrical plug based on the United Kingdom standard.

Still referring to FIG. 5, conductive strip assembly 150 comprises a first conductive strip 152 and a second conductive strip 162. In some embodiments, first conductive strip 152 is an L-shaped structure that includes an elongated stem portion 153 and a short arm portion 154 oriented perpendicular to elongated stem portion 153. Elongated stem portion 153 includes a first seat 155, one or more first peg through holes 159 and a first circuit board connector 157. First circuit board connector 157 of first conductive strip 152 includes a tab 158 which inserts into circuit board 200 thereby establishing electrical communication between first conductive strip 152 and circuit board 200. First seat 155 is position in elongated stem portion 153 to operationally engage first conductive projection 136 when first prong 134 is in a first plug position as described below. First peg through holes 159 are positioned in elongated stem portion 153 to operationally engage one or more first pegs 93 of first conductive strip platform 92. First circuit board connector 157 is oriented perpendicular to elongated stem portion 153 and in a direction opposite to short arm portion 154 of first conductive strip 152. A second seat 156 is position in short arm portion 154 to operationally engage first conductive projection 136 when first prong 134 is in a second plug position as described below. As such, first conductive strip 152 is configured to engage first conductive projection 136 of integral plug 152 at first conductive seat 155 or second seat 156 depending on orientation of integral plug 152.

Similarly, second conductive strip 162 is an L-shaped structure that includes an elongated stem portion 163 and a short arm portion 164 oriented perpendicular to elongated stem portion 163. Elongated stem portion 163 includes a first seat 165, one or more second peg through holes 169 and a second circuit board connector 167. Second circuit board connector 167 of second conductive strip 162 includes a tab 168 which inserts into circuit board 200 thereby establishing electrical communication between second conductive strip 162 and circuit board 200. First seat 165 is position in elongated stem portion 163 to operationally engage second conductive projection 137 when second prong 135 is in a first plug position as described below. Second peg through holes 169 are positioned in elongated stem portion 163 to operationally engage one or more second pegs 95 of second conductive strip platform 94. Second circuit board connector 167 oriented perpendicular to elongated stem portion 163 and in a direction opposite to short arm portion 164 of second conductive strip 162. A second seat 166 is position in short arm portion 164 to operationally engage second conductive projection 137 when second prong 135 is in a second plug position as described below. As such, second conductive strip 162 is configured to engage second conductive projection 137 of integral plug 152 at first conductive seat 165 or second seat 166 depending on orientation of integral plug 152.

As shown in FIG. 5, securing cover 170 of plug housing assembly 60 comprises an external surface 171, an internal surface 172, one or more first pegs through holes 173, one or more second pegs through holes 175, a fastener through hole 176, a first securing tab 178, a second securing tab 179, and a third securing tab 180. One or more first pegs through holes 173 are positioned on securing cover 170 to operationally align with one or more first pegs 93 of first conductive strip platform 92 while one or more second pegs through holes 175 are positioned on securing cover 170 to operationally align with one or more second pegs 95 of second conductive strip platform 94. Fastener through hole 176 is positioned on securing cover 170 to operationally align with threaded blind hole 96 of plug assembly support 90. Fastener through hole 176 can be optionally countersunk to create a flat surface when a fastener 177 is secured to securing cover 170. First securing tab 178 is positioned to operationally engage through hole 122 of axle stop 120. Second securing tab 179 is positioned to operationally engage through hole 97 located at the end of first conductive strip platform 92. Similarly, third securing tab 180 is positioned to operationally engage through hole 98 located at the end of second conductive strip platform 94.

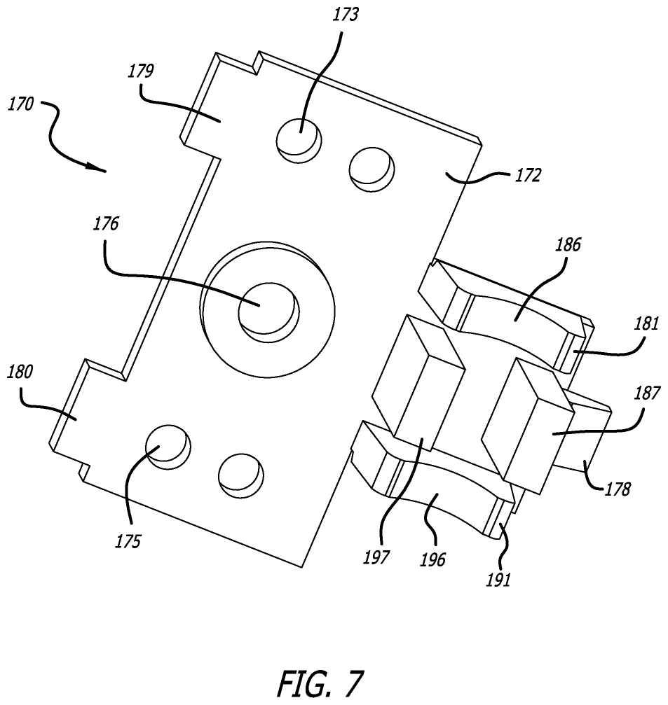

As shown in FIG. 7, internal surface 172 of securing cover 170 is dimensioned and sized to configure with the contours of plug assembly mount 90. In some embodiments, internal surface 172 includes a first prong chamber cover 181 that includes a first yoke cover 186 and a first axle cover 187, and a second prong chamber cover 191 that includes a second yoke cover 196 and a second axle cover 197. First prong chamber cover 181 is positioned on securing cover 170 to operationally align with first prong chamber 101 so that first yoke cover 186 aligns with first outside yoke 106 and first axle cover 187 aligns behind axle 140. Similarly, second prong chamber cover 191 is positioned on securing cover 170 to operationally align with second prong chamber 111 so that second yoke cover 196 aligns with second outside yoke 116 and second axle cover 197 aligns in front of axle 140.

In some embodiments, internal surface 172 includes a first prong chamber cover 181 that includes a first outside yoke cover 186, a first axle cover 187, and a first inside yoke cover (not shown), and a second prong chamber cover 191 that includes a second outside yoke cover 196, a second axle cover 197, a second inside yoke cover (not shown). First prong chamber cover 181 is positioned on securing cover 170 to operationally align with first prong chamber 101 so that first outside yoke cover 186 aligns with first outside yoke 106, first axle cover 187 aligns behind axle 140, and aligns with first inside yoke 107. Similarly, second prong chamber cover 191 is positioned on securing cover 170 to operationally align with second prong chamber 111 so that second outside yoke cover 196 aligns with second outside yoke 116, second axle cover 197 aligns in front of axle 140, and second inside yoke cover aligns with second inside yoke 117.

Referring to FIGS. 2 & 3, charger 12 also comprises a circuit board 200 sized and dimensioned to operationally fit into internal chamber 40 of charger housing top 20. In some embodiments, and referring to FIGS. 2 & 3, circuit board 200 includes a first surface 201 and a second surface 202 opposite first surface 201. In some embodiments, circuit board 200 comprises a battery 206 and a power port 208, with both battery 206 and power port 208 located on first surface 202. Circuit board 200 comprises, for example, a printed circuit board (PCB), such as, e.g., a normal PCB or a fast charging PCB, that mechanically supports and electrically integrates the electronics associated with integral plug 132, adaptor assembly 14 and a device, thereby establishing electrical communication thereof. In one embodiment, circuit board 200 is a 65 W PCB. Battery 206 powers the circuit board, stores energy when charger 12 is plugged into an electrical outlet, and releases energy to a device when the device is operationally connected to charger 12. Power port 208 is configured to receive plug 17 of power cord 16. Power port 208 and plug 17 of power cord 16 can be configured to be a USB-type port and plug, a lightning connector and port, a mini power port, a mini USB and the like so that power cord 16 that connects charger 12 to a device, as known in the art. Circuit board 200 can further comprise for example, one or more transformers having copper plates which facilitate heat dissipation, one or more switches that halt or enable the flow of current, one or more connectors useful for connecting the circuit board to other boards and devices, one or more diodes, one or more transistors like gallium arsenide (GaAs) transistors or gallium nitride (GaN) transistors, one or more resistors, one or more relays, one or more integrated circuits, one or more light emitting diodes (LEDs), and/or one or more inductors.

Referring to FIG. 3, circuit board 200 can further, and optionally, comprise a heat shield 210 used as a thermal sink to dissipate and reduce heat generated by circuit board 200 that could negatively affect the operation of circuit board 200, charger 12, and/or charger system 10. Heat shield 210 has a first surface and a second surface opposite first surface and sized and dimensioned to operationally cover second side 204 of circuit board 200 with the first surface of heat shield 210 interfacing with second surface 204. In some embodiments, heat shield 210 further comprises one or more sides that extend perpendicularly from the first surface to further partially encase circuit board 200. In some embodiments, one or more sides of heat shield 210 can optionally have one or more further extensions that are perpendicular to the one or more sides and parallel with the first side of heat shield 210 to even further encase circuit board 200. In some embodiments, heat shield 210 is secured to second surface 204 of circuit board 200 via a friction fit and/or by using an adhesive, such as, e.g., a glue or a tape, a fastener, such as, e.g., a screw or rivet, or by fusing, such as, e.g., by soldering, welding or otherwise fusion together complementary attachment points. In some embodiments, heat shield 210 is composed of a heat conductive or dissipating material such as, e.g., a metal.

Referring to FIG. 3, circuit board 200 can further, and optionally, comprise an electromagnetic shield 212 used as a protective block that prevents or reduces incoming or outgoing electromagnetic fields that could negatively affect the operation of circuit board 200, charger 12, and/or charger system 10. Electromagnetic shield 212 has a first surface and a second surface opposite first surface and sized and dimensioned to operationally cover second side 204 of circuit board 200. In some embodiments, typically when heat shield 210 is absent, the first surface of electromagnetic shield 212 interfaces directly with second surface 204 of circuit board 200. In some embodiments, when heat shield 210 is present, the first surface of electromagnetic shield 212 interfaces directly with the second surface of heat shield 210. In some embodiments, electromagnetic shield 212 further comprises one or more sides that extend perpendicularly from the first surface to further partially encase circuit board 200 and, if present heat shield 210. In some embodiments, one or more sides of electromagnetic shield 212 can optionally have one or more further extensions that are perpendicular to the one or more sides and parallel with the first side of heat shield 210 to even further encase circuit board 200 and, if present heat shield 210. In some embodiments, electromagnetic shield 212 is composed of an conductive or magnetic material such as, e.g., a metal like copper, brass, nickel, silver, steel, and tin formed into a sheet, screen or foam.

Still referring to FIG. 3, charger 12 can further, and optionally, comprise a ferrite shield 220 used as a protective block that prevents or reduces incoming or outgoing electromagnetic fields that could negatively affect the operation of circuit board 200, charger 12, and/or charger system 10. Ferrite shield 220 has a first surface and a second surface opposite first surface and sized and dimensioned to operationally fit into internal chamber 40 of charger housing top 30. In some embodiments, ferrite shield 220 is secured to internal surface 31″ of charger housing top 30 via a friction fit and/or by utilizing an adhesive, such as, e.g., a glue or a tape. In some embodiments, and referring to FIG. 3, an adhesive tape 222 is used to secure ferrite shield 220 to internal surface 31″ of charger housing top 30.

During assembly of charger 12, and referring to FIGS. 2, 3 & 5, integral plug assembly 130 is first installed to plug housing assembly 60 of charger bottom 50. Initially, and referring to FIG, 4, integral plug 132 is operationally positioned onto plug assembly support 90 of plug housing assembly 60 by inserting first and second prongs 134, 135 through first and second prong channels 108, 118 of first and second prong chambers 101, 111, respectively and then placing first outside pivot 142 on first outside yoke 106, first inside pivot 144 on first inside yoke 107, second outside pivot 146 on second outside yoke 116, and second inside pivot 148 on second inside yoke 117. Conductive strip assembly 150 is then operationally positioned onto conductive strip support 91 of plug assembly support 90. This can be achieved by inserting first pegs 93 of first conductive strip platform 92 through first peg through holes 159 of first conductive strip 152 in an orientation where elongated stem portion 153 of first conductive strip 152 rests on first conductive strip platform 92 with first circuit board connector 157 extending perpendicular from first conductive strip platform 92 and short arm 154 of first conductive strip 152 positioned adjacent to first conductive projection slot 109. Second conductive strip 162 is operationally positioned onto second conductive strip platform 94 by inserting second pegs 95 of second conductive strip platform 94 through second peg through holes 169 of second conductive strip 162 in an orientation where elongated stem portion 163 of second conductive strip 162 rests on second conductive strip platform 94 with second circuit board connector 167 extending perpendicular from second conductive strip platform 94 and short arm 164 of second conductive strip 162 positioned adjacent to second conductive projection slot 119.

Still referring to FIG. 5, once integral plug assembly 130 and conductive strip assembly 150 are properly installed, securing cover 170 is secured to plug housing assembly 60 of charger bottom 50. Securing cover 170 is initially positioned in a manner where second securing tab 179 of securing cover 170 is inserted into a through hole located at the end of first conductive strip platform 92, third securing tab 180 of securing cover 170 are inserted into a through hole located at the end of second conductive strip platform 94, and then first securing tab 179 of securing cover 170 is inserted into through hole 122 of axle stop 120 by bending axle stop 120 back from plug mount assembly 90 to align first securing tab 179 with through hole 122 and allowing axle stop 120 to flex back into place. At the same time, 1) first prong chamber cover 181 is aligned with first prong chamber 101 so that first outside yoke cover 186 abuts with first outside yoke 106 and first inside yoke cover 187 abuts with first inside yoke 107, thereby capturing first outside pivot 142 and first inside pivot 144 of integral plug 132, respectively; 2) second prong chamber cover 191 is aligned with second prong chamber 111 so that second outside yoke cover 196 abuts with second outside yoke 116 and second inside yoke cover 197 abuts with second inside yoke 117, thereby capturing second outside pivot 146 and second inside pivot 148 of integral plug 132, respectively; 3) first pegs 93 of first conductive strip platform 92 are inserted through first peg through holes 173 of securing cover 170; and 4) second pegs 95 of second conductive strip platform 94 are inserted through second peg through holes 175 of securing cover 170. Once securing cover 170 is properly positioned on plug housing assembly 60, fastener 177 is inserted through fastener through hole 176 of securing cover 170 and secured into threaded blind hole 96 of plug assembly support 90.

Referring now to FIGS. 2 & 3, circuit board 200, alone or preassembled with heat shield 210 and/or electromagnetic shield 212, is operationally aligned and secured to charger housing bottom 50. Circuit board 200 can be secured to charger housing bottom 50 by employing attachment points present on circuit board 200 that are operationally align and complementary with attachment points present on charger housing bottom 50. Such complementary attachment points can be securing using an adhesive, such as, e.g., a glue or a tape, a fastener, such as, e.g., a screw or rivet, or by fusing, such as, e.g., by soldering, welding or otherwise fusion together complementary attachment points.

Referring to FIGS. 2 & 3, First, second, and third magnets 45, 45, 47 are properly affixed to first, second, and third magnet seats 42, 43, 44, and if present fourth magnet 48 is properly affixed to the fourth magnet seat, of charger housing top 30. If present, ferrite shield 220, is then affixed to internal surface 31″ of charger housing top 30. Once circuit board 200 is installed onto charger housing bottom 50, charger housing top 30 can then be secured to charger housing bottom 50. Charger housing top 30 is place over charger housing bottom 50 so that perimeter 37′ of notch 37 is in alignment with and abuts the perimeter of plug housing assembly 60, plug aperture 38 is in alignment with power port 208, and first, second, third, and fourth sides 53, 54, 55, 56 of charger housing bottom 50 abut first, second, third, and fourth internal surfaces 33″, 34″, 35″, 36″ of charger housing top 30 in close proximity to perimeter edge 41 in a manner that encloses internal chamber 40 from the outside environment. Charger housing top 30 can be secured to charger housing bottom 50 by employing attachment points present on charger housing top 20 that are operationally align and complementary with attachment points present on charger housing bottom 50. Such complementary attachment points can be securing using an adhesive, such as, e.g., a glue or a tape, a fastener, such as, e.g., a screw or rivet, or by fusing, such as, e.g., by soldering, welding or otherwise fusion together complementary attachment points.

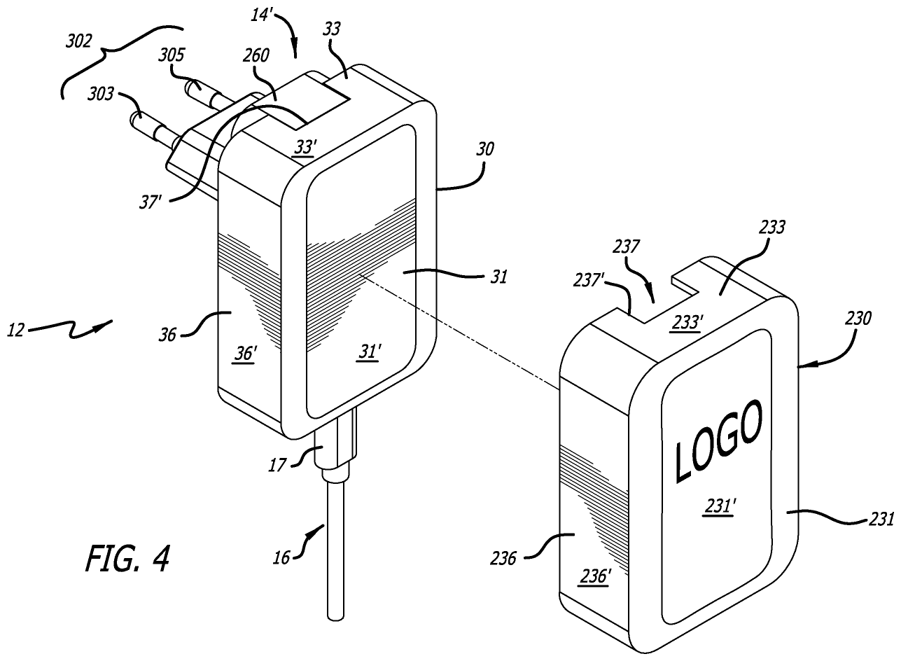

Charger 12 can optionally include a removeable cover 230. It is contemplated that removeable cover 230 can be provided in various configurations/shapes, to fit over charger housing 20, as securable, releasable communication between charger case 12 and removeable cover 230 may be provided via a friction fit and/or respective magnets in accordance with the teachings of the present disclosure. In another aspect of the disclosure, charger 12 is provided with the ability of end-user customization. In one aspect, such customization is provided by the fact that removeable cover 230 is releasably secured to charger case 12 and, accordingly, may be exchanged to for another removeable cover 230 having indicia thereon, depending upon the desire of a user. For example, indicia may be any one or any combination of a design, a brand logo, a sports team logo or a company logo, for example, and as shown in FIG. 4. It is contemplated that charger 12 and charger system 10 may be provided with a plurality of removeable covers 230 so that a user may easily impart their own desired aesthetic to their charger at any given to thus personalize their charger, For example, if the user is a fan of a particular sports team, removeable cover 230, may be provided with a team logo or mascot, for example. In another iteration, removeable cover 230 or any portion thereof may be provided in a color that is different than the color of charger housing 20. In another example, the charger and system of the instant disclosure may comprise a plurality of removeable covers 230 each being a color different from each other or having a particular color pattern, design or logo, for example, to impart a degree of personalization to charger 12.

In some embodiments, and referring to FIGS. 2 & 4, removeable cover 230 includes a top 231, a first side wall 233, a second side wall 234, a third side wall 235, and a fourth side wall 236, with first, second, third and fourth side walls 233, 234, 235, 236 extending perpendicular from top 231, thereby defining a 4-sided internal chamber 240 with a perimeter edge 241. First side wall 233 is opposite to third side wall 235 and first side wall 233 is generally parallel to third side wall 235. Similarly, second side wall 234 is opposite to fourth side wall 236 and second side wall 234 is generally parallel to fourth side wall 236. Second and fourth side walls 234, 236 span between first and third side walls 233, 235 and are substantially perpendicular to first and third side walls 233, 235. Top 231 has an external surface 231′ and an internal surface 231″ opposite the external surface 231′. Likewise, first side wall 233 has an external surface 233′ and an internal surface 233″ opposite the external surface 233′, second side wall 234 has an external surface 234′ and an internal surface 234″ opposite the external surface 234′, third side wall 235 has an external surface 235′ and an internal surface 235″ opposite the external surface 235′, and fourth side wall 236 has an external surface 236′ and an internal surface 236″ opposite the external surface 236′. First side wall 233 includes a notch 237 having a perimeter 237′ configured to provide clear access of a mounting base of an adapter assembly disclosed herein into and out of adaptor mount 62 of charger 12. As such, removeable cover 230 includes notch 237 that is similarly dimensioned and sized as notch 37 of charger housing top 30. Third side wall 235 includes a plug aperture 238, a through hole configured to allow passage of plug 17 of power cord 16 which enables insertion of plug 17 into power port 208 of circuit board 200.

In some embodiments, and referring to FIG. 2, internal surface 231″ of top 231 comprises a first magnet seat 242, a second magnet seat 243, and a third magnet seat 244, each configured to house a magnet 245, 246, 247, respectively. Magnets 245, 246, 247 can be fitted into first, second, and third magnet seats 242, 243, 244 via a friction fit and/or by utilizing an adhesive, such as, e.g., a glue or a tape, to secure magnets 245, 246, 247 to first, second, and third magnet seats 242, 243, 244. First, second, and third magnet seats 242, 243, 244 are configured and spaced apart so that their respective magnets 245, 246, 247 operationally engage with magnets 45, 46, 47 located within charger housing top 30.

In some embodiments, and referring to FIGS. 3 & 15, removeable cover 230 comprises magnets 245, 246, 247, 248. Magnets 245, 246, 247, 248 can be fitted into the first, second, third, and fourth magnet seats located in internal surface 231″ of top 231 via a friction fit and/or by utilizing an adhesive, such as, e.g., a glue or a tape, to secure magnets 245, 246, 247, 248 to the first, second, third, and fourth magnet seats. In some embodiments, and referring to FIG. 3, adhesive tape 256 is used to secure magnets 245, 246, 247, 248 to internal surface 31″ magnets 245, 246, 247, 248 of charger housing top 30. First, second, third, fourth magnet seats are configured and spaced apart so that their respective magnets 245, 246, 247, 248 operationally engage with magnets 45, 46, 47, 48 located at charger housing top 30.

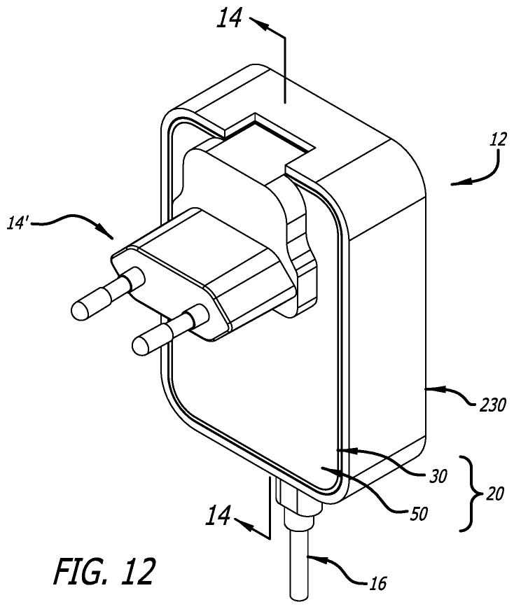

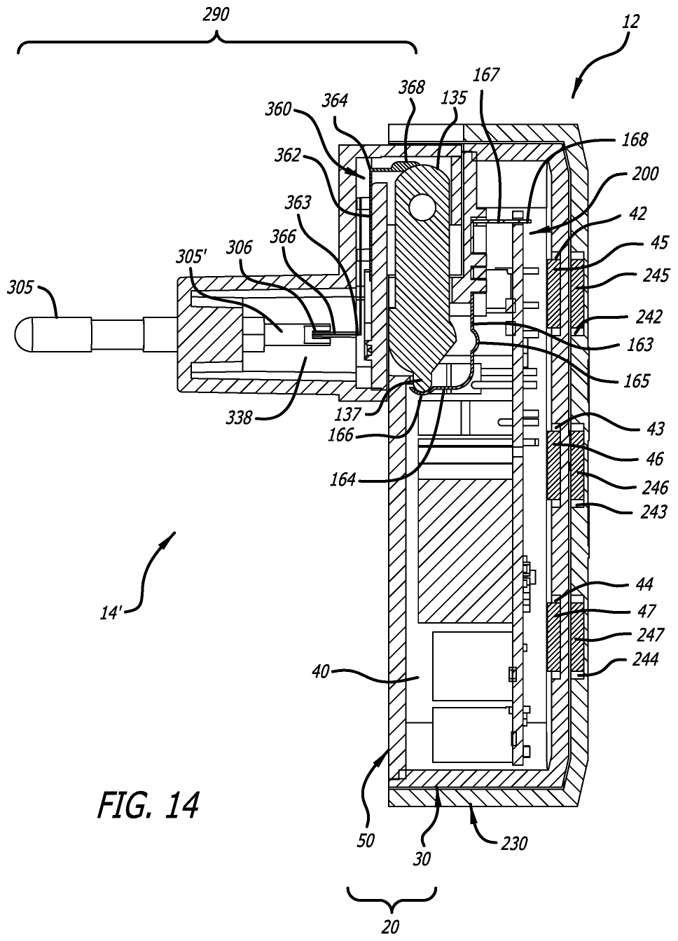

In some embodiments, one or more magnet present in removeable cover 230 are configured to be in substantial alignment and proximity to one or more magnets present in charger housing top 30, once removeable cover 230 is fitted onto charger housing 20, such that the one or more magnets of charger housing top 30 is substantially superimposed and attracted by its complimentary and substantially aligned one or more magnet of removeable cover 230. For example, referring to FIGS. 13 & 14, which are cross-sectional views of charger 12 fitted with removeable cover 230, with FIG. 13 taken along line 13-13 of FIG. 1 and FIG. 14 taken along line 14-14 of FIG. 12, an exemplary alignment of magnets present in charger housing top 30 and removeable cover 230 is shown. Here, first, second, and third magnet 245, 246, 247 of removeable cover 230 are in substantial alignment and proximity to first, second, and third magnet seats 42, 43, 44 in charger housing top 30. The magnetic poles of first, second, and third magnet seats 42, 43, 44 in charger housing top 30 are oriented such that the magnetic force respectively attract first, second, and third magnet 245, 246, 247 of removeable cover 230. This substantially superimposed alignment provides an attractive magnetic force between removeable cover 230 and charger housing 20 to provide releasable securing of one with the other.

In some embodiments, the attractive and repulsive magnetic forces of magnets disclosed herein are arranged in a manner to enable attachment of removable cover 230 in only one orientation relative to charger housing top 30 of charger housing 20. For example, and referring to FIG. 2, first and second magnet seats 42, 43 of charger housing top 30 can position their respective magnets 45, 46 to eminent an attractive magnetic force relative to the magnets 245, 246 of first and second magnet seats 242, 243 of removable cover 230 while third magnet seat 44 can position magnet 47 to eminent a repulsive magnetic force relative to magnet 247 of third magnet seat 244 of removable cover 230. Likewise, first and second magnet seats 242, 243 of removeable cover 230 can position their respective magnets 245, 246 to eminent a repulsive magnetic force relative to the magnets 45, 46 of first and second magnet seats 42, 43 of charger housing top 30 while third magnet seat 244 can position magnet 247 to eminent an attractive magnetic force relative to magnet 47 of third magnet seat 44 of charger housing top 30. In this way, magnets 245, 246, 247 of removeable cover 230 can only engage magnet 45, 46, 47 of charger housing top 30 in one orientation due to the magnetic forces generated from the orientation of these magnets; any other orientation between charger housing top 30 and removeable cover 230 will result in magnetic repulsion of removeable cover 230 away from charger housing top 30 of charger 12. Similar arrangements of magnets 245, 246, 247, 249 can create attractive and repulsive magnetic forces of magnets disclosed herein in a manner to enable attachment of removable cover 230 as shown in FIG. 3 in only one orientation relative to charger housing top 30 of charger housing 20.

Referring to FIGS. 2 & 3, first, second, and third magnets 245, 246, 247 are properly affixed to first, second, and third magnet seats 242, 243, 244, and if present fourth magnet 249 is properly affixed to the fourth magnet seat, of removeable cover 230. If present, protective pad 252, is then affixed to internal surface 231″ of removeable cover 230.

A charger system 10 can optionally include one or more additional removeable covers 230 to removeable cover 230 provided on charger 12. For example, a charger system 10 can one additional removeable cover 230, two additional removeable covers 230, three additional removeable covers 230, four additional removeable covers 230, or five additional removeable covers 230. Such additional removeable covers can be identical in ornamental design removeable cover 230 or have a different ornamental design to removeable cover 230 as well as to other removeable covers 230 provided in charger system 10. A removeable covers 230 can also be provided separately to user from charger system 10.

Still referring to FIG. 3, removeable cover 230 can further, and optionally, comprise a protective pad 252. In some embodiments, protective pad 252 is used as a protective block that prevents or reduces scratches, scuffing, or other surface damage of removeable cover 230 and charger housing 20. In some embodiments, alternatively, or in addition to a protective block function, protective pad 252 can be used as a shock absorber that prevents or reduces damage to the electrical and mechanical components of charging system 10 and charger 20 due to unwanted impact. Protective pad 252 has a first surface and a second surface opposite first surface and sized and dimensioned to operationally fit into internal chamber 240 of charger removeable cover 230. In some embodiments, protective pad 252 is secured to internal surface 231″ of removeable cover 230 via a friction fit and/or by utilizing an adhesive, such as, e.g., a glue or a tape. In some embodiments, and referring to FIG. 3, an adhesive tape 254 is used to secure protective pad 252 to internal surface 231″ of removeable cover 230. In some embodiments, protective pad 252 is composed of an elastic or flexible material such as, e.g., an organic or synthetic rubber or a polyester or urethane form.

Removable cover 230 can further, and optionally, be configured to provide an internal storage compartment formed when removeable cover 230 is placed atop charger housing 20, the internal storage compartment being a space formed between internal surface 231″ of top 231 of removeable cover 230 and external surface 31′ of top 31 of charger housing top 30. For example, in some embodiments, internal surface 231″ of top 231 of removeable cover 230 can comprise ridges that create an offset between removeable cover 230 and charger housing top 30. Such ridges can be located in one or more corners of removeable cover 230 or be arranged in a pattern where the ridges also form clasps that secure all or a portion of a power cord disclosed herein, like power cord 16. Alternatively, in some embodiments, internal surface 31″ of top 31 of charger housing top 30 can comprise ridges that create an offset between removeable cover 230 and charger housing top 30, which similarly, can be located in one or more corners of charger housing top 30 or be arranged in a pattern where the ridges also form clasps that secure all or a portion of a power cord disclosed herein, like power cord 16.

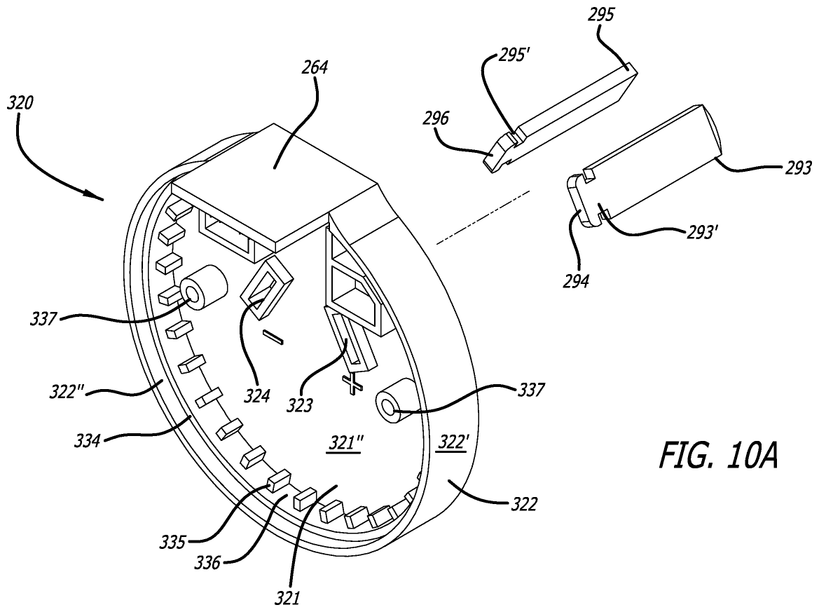

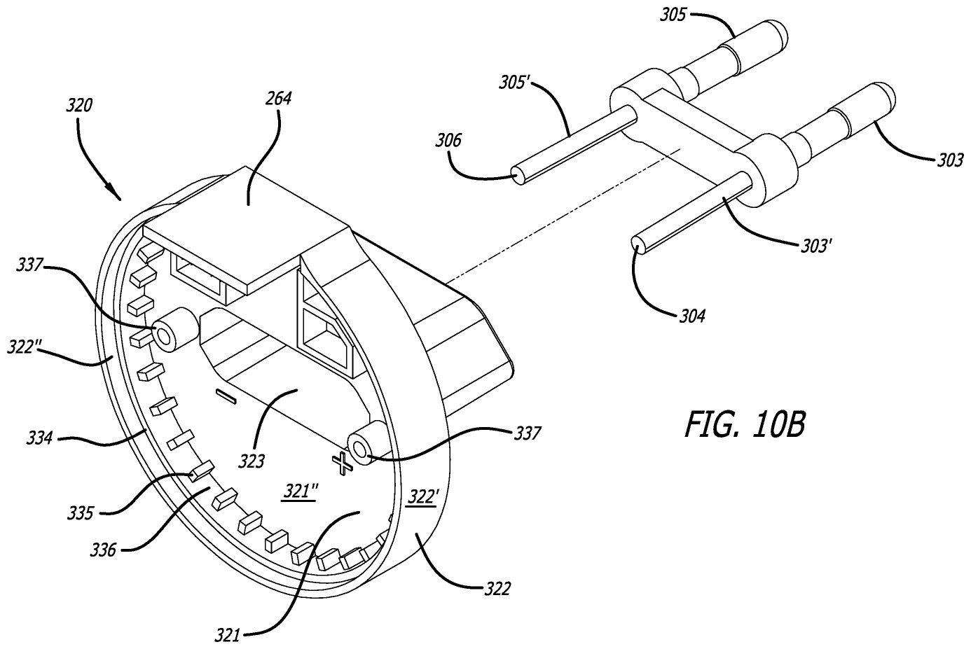

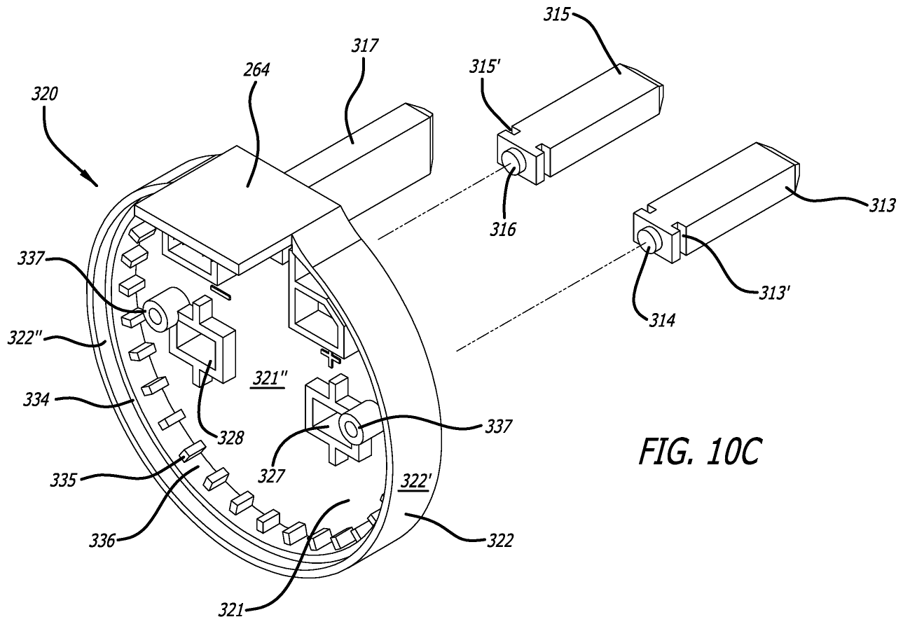

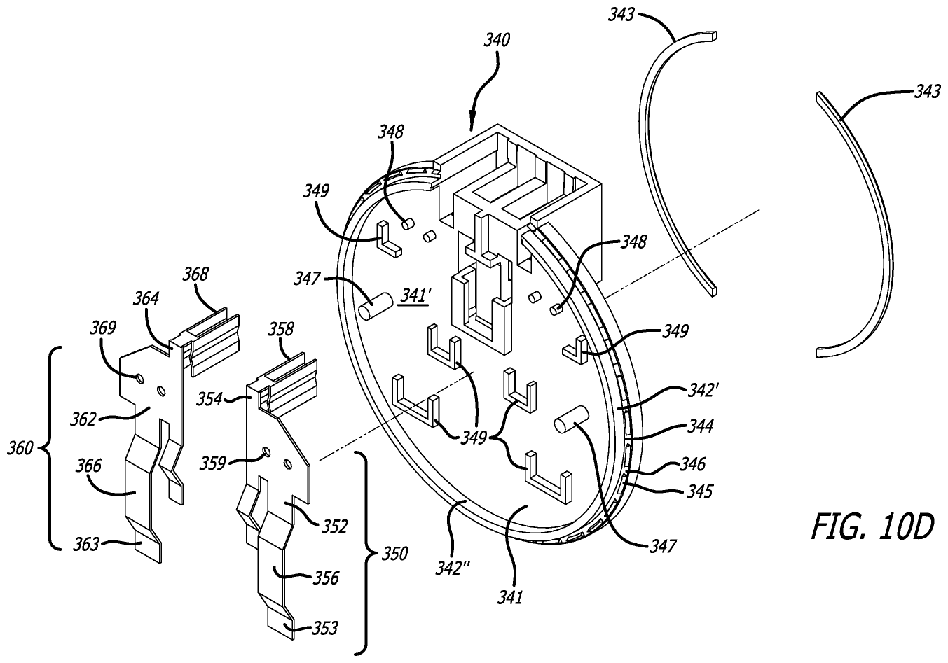

In some embodiments, and referring to FIGS. 1 & 9, adaptor assembly disclosed herein, such as adaptor assembly 14, 14′, and 14″, comprises a mounting base 260, an adaptor plug assembly 290, and a housing 250. Housing 250 sized and dimensions to operationally interface with external surface 51 of charger housing bottom 50 can be operationally configured in any shape. In some embodiments, and referring to FIG. 1, housing 250 is shaped like a shield. In some embodiments, and referring to FIG. 10A-D, housing 250 is circular in shape. In some embodiments, and referring to FIGS. 10A-D, housing 250 comprises a top adaptor housing 320, a bottom adaptor housing 340, a first adaptor conductive strip 350, and a second adaptor conductive strip 360. As best seen in FIGS. 1 & 9, top adaptor housing 320 includes an external surface 321′ and bottom adaptor housing 340 including an external surface 341′, with adaptor plug assembly 290 positioned on external surface 321′ and mounting base 260 positioned on external surface 341′.

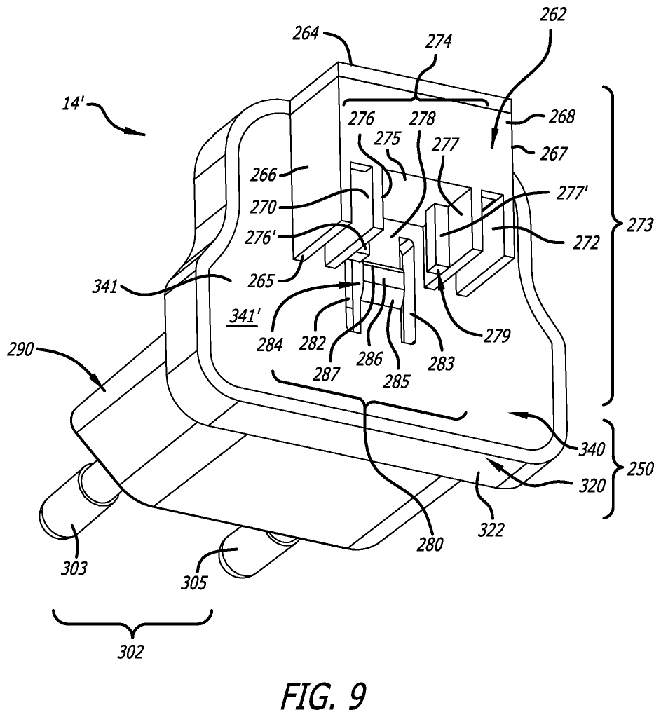

In some embodiments, and referring to FIG. 9, mounting base 260 of an adaptor assembly disclosed herein comprises a body 262 having a front side 264, a back side 265, a first side 266, a second side 267 and a third side 268. Front side 264 is opposite to back side 265 and front side 264 is generally parallel to back side 265. Similarly, first side 266 is opposite to second side 267 and first side 266 is generally parallel to second side 267. First and second sides 266, 267 span between front and back sides 264, 265 and are substantially perpendicular to front and back sides 264, 265 to create a four-sided structure. Third side 268 is defined by the perimeter formed by front, back, first, and second sides 264, 265, 266, 267. The dimensions of mounting base 260 are configured to operationally insert and releasably engage with adaptor mount 62 of plug housing assembly 60 of charger 12 to form a tight fit with back, first, second, and third sides 265, 266, 267, 268 of mounting base 260 abutting back, first, second, and third sides 65, 66, 67, 68 of adaptor mount slot 64 in a manner that operationally connects adaptor assembly 14 with charger 12.

Referring to FIG. 9, back side 265 of mounting base 260 includes a first prong channel 270, a second prong channel 272, and a latch lock assembly 273. First prong channel 270 is an opening within back side 265 that extends from external surface 341′ of bottom adaptor housing 340 to third surface 268 and is positioned and configured to receive first prong 134 of integral plug 132. Similarly, second prong channel 272 is an opening within back side 265 that extends from external surface 341′ of bottom adaptor housing 340 to third surface 268 and is positioned and configured to receive second prong 135 of integral plug 132. Latch lock assembly 273 is positioned on back side 265 in between first and second prong channels 270, 272 and comprises a latch lock slot 274 and a latch lock 280. Latch lock slot 274 comprises a channel defined by a back side 275, a first side 276, a second side 277, a third side 278, and a front opening 279. First side 276 is opposite to second side 277 with third side 278 spanning between first side 276 and second side 277; third side 278 being an extension of external surface 341′ of bottom adaptor housing 340. First side 276 is generally parallel to second side 277, with third side 278 being substantially perpendicular to the two. First side 276 includes a ridge 276′ which is substantially parallel to third side 278 and extends the length of first side 276 from back side 275 to front opening 279. Similarly, second side 277 includes a ridge 277′ which is substantially parallel to third side 278 and extends the length of second side 277 from back side 275 to front opening 279. Ridges 276′, 277′ are configured to insert into and operationally engage first groove 74 and second groove 77, respectively, of mounting plug 70 when an adaptor assembly, like adaptor assembly 14, 14′, or 14″ is operationally secured to charger 12. First, second, and third sides 276, 277, 278 form three-sided, U-shaped channel having a closed end defined by back side 275 and an open end defining front opening 279. The dimensions of the three-sided U-shaped channel thus formed are configured to receive and releasably engage adaptor mounting plug 70 of adaptor mount 62 of charger 12. Engagement of latch lock assembly 273 to adaptor mount slot 64 adapter secures adaptor assembly 14 to charger 12 in a manner that resists loosening of the engagement of adapter assembly 14 to charger 12 under handling/vibrations and torque.

Still referring to FIG. 9, latch lock slot 274 also includes a latch lock 280 which is positioned on third side 278 of latch lock slot 274. Latch lock 280 comprises a first rail 282, a second rail 283 and a bolt 284 with bolt 284 located between first and second rails 282, 283 at a position midway along the length of first and second rails 282, 283 thereby forming an H-shaped structure. First and second rails 282, 283 are aligned in a parallel direction to first and second sides 276, 277 of latch lock slot 274. Bolt 284 can be of any geometrical shape as long as bolt 284 robustly, releasably and complimentarily engages with the internal geometry engagement box 84 of latch box 80. In some embodiments, bolt 284 is a three-sided structure with a leading edge 285, a top edge 286, and a trailing edge 287 and configured to operationally engage engagement box 84 of latch box 80.

Adaptor plug assembly 290 of an adaptor assembly disclosed herein comprises an adaptor plug. In some embodiments, as shown in FIGS. 1 & 10A, adaptor plug assembly 290 comprises an adaptor plug 292 with a first adaptor prong 293 and a second adaptor prong 295 based on the Australian electrical plug standard. First adaptor prong 293 includes an internal portion 293′ having a connector 294 at its terminus, with connector 294 configured to operationally engage a prong tab 356 of first conductive strip 350 upon assembly. Similarly, second adaptor prong 295 includes an internal portion 295′ having a connector 296 at its terminus, with connector 296 configured to operationally engage a prong tab 366 of second conductive strip 360 upon assembly. In some embodiments, as shown in FIGS. 1 & 10B, adaptor plug assembly 290 comprises an adaptor plug 302 with a first adaptor prong 303 and a second adaptor prong 305 based on the European Union electrical plug standard. First adaptor prong 303 includes an internal portion 303′ having a connector 304 at its terminus, with connector 304 configured to operationally engage prong tab 356 of first conductive strip 350 upon assembly. Similarly, second adaptor prong 305 includes an internal portion 305′ having a connector 306 at its terminus, with connector 306 configured to operationally engage prong tab 366 of second conductive strip 360 upon assembly. In some embodiments, as shown in FIGS. 1 & 10C, adaptor plug assembly 290 comprises an adaptor plug 312 with a first adaptor prong 313, a second adaptor prong 315, and a third adaptor prong 317 based on the United Kingdom electrical plug standard. First adaptor prong 313 includes an internal portion 313′ having a connector 314 at its terminus, with connector 314 configured to operationally engage prong tab 356 of first conductive strip 350 upon assembly. Similarly, second adaptor prong 315 includes an internal portion 315′ having a connector 316 at its terminus, with connector 316 configured to operationally engage prong tab 366 of second conductive strip 360 upon assembly. With respect to third adaptor prong 317, when configured to make an electrical connection, adaptor prong 317 includes an internal portion having a connector at its terminus, with the connector configured to operationally engage second conductive strip upon assembly. In some embodiments, adaptor plug assembly 290 comprises an adaptor plug with a first adaptor prong and a second adaptor prong based on the United States of America electrical plug standard (not shown).

Referring to FIGS. 1, 9 & 10A-C, top adaptor housing 320 of housing 250 of an adaptor assembly disclosed herein includes a bottom 321 having external surface 321′ and an internal surface 321″, and one or more sides, shown as side 322, with each side having an external surface 322′ and an internal surface 322′. A portion of top adaptor housing 320 is configured to form front side 264 of body 262 of mounting base 260. Top adaptor housing 320 is configured to comprise one or more electrical plug ports, each being a through hole sized and dimensioned to properly orient and securely affix an electrical plug disclosed herein. In some embodiments, and referring to FIG. 10A, top adaptor housing 320 comprises a first electrical plug port 323 and a second electrical plug port 324, each being configured securely affix first adaptor prong 293 and second adaptor prong 295, respectively, of adaptor plug 292. In some embodiments, and referring to FIG. 10B, top adaptor housing 320 comprises a first electrical plug port 325 and a second electrical plug port 326, each being configured securely affix first adaptor prong 303 and second adaptor prong 305, respectively, of adaptor plug 302. In some embodiments, and referring to FIG. 10C, top adaptor housing 320 comprises a first electrical plug port 327 and a second electrical plug port 328, each being configured securely affix first adaptor prong 313 and second adaptor prong 315, respectively, of adaptor plug 312. With respect to top adaptor housing 320, third adaptor prong 317 can be an integral part of top adaptor housing 320, being located on external surface 321′ and typically composed, at least in part, of the same material used to make top adaptor housing 320. Alternatively, third adaptor prong 317 can be a separate component of top adaptor housing 320, in which case a third adaptor port is present configured securely affix third adaptor prong 317 in a manner similar to first and second adaptor prongs 313, 315.

As shown in FIGS. 10A-C, internal surface 321″ of bottom 321 contains one or more securing posts 337, each securing post 337 having a blind hole configured to receive a housing securing pin disclosed herein. Internal surface 322″ of side 322 includes a recess to form a rabbet 324 along the perimeter of internal surface 322″ except where front side 264 of body 262 of mounting base 260 is located. Rabbet 334 further includes a series of spaced apart ridges 335 with each pair of ridges 335 forming a groove 336 therebetween. This series of ridges 335 and grooves 336 are configured to receive a complementary series of ridges and grooves disclosed herein located on bottom adaptor housing 340 to ensure that top adaptor housing 320 and bottom adaptor housing 340 are properly oriented to one another during assembly.

Referring to FIG. 10D, bottom adaptor housing 340 of housing 250 of an adaptor assembly disclosed herein includes a top plate 341 having external surface 341′ and an internal surface 341″, and one or more sides, shown as side 342, with each side having an external surface 342′ and an internal surface 342′. A portion of bottom adaptor housing 340 is configured to form body 262 of mounting base 260 (with the exception of front side 264 which is part of top adaptor housing 320. Bottom adaptor housing 340 is sized and configured to fit onto top adaptor housing 320 so that top plate 341 is opposite bottom 321 and an internal chamber 338 is created. Bottom adaptor housing 340 can also optionally include a protection pad 343 located on external surface 341′ of top plate 341. Protection pad 343 guards external surface 341′ of top plate 341 against scratches, scuffing and other damage potentially caused by repeated attachment and detachment of adaptor assembly 14 to charger 12.

As shown in FIG. 10D, internal surface 341″ of top plate 341 contains one or more housing securing pins 347, each housing securing pin 347 being a protrusion sized and dimensioned to operationally insert into its respective blind hole of securing post 337. Internal surface 341″ of top plate 341 also includes one or more conductive strip pins 348 and one ore more conductive strip securing ridges 349 each configured to properly orient first and second adaptor conductive strips 350, 360. External surface 342′ of side 342 includes a recess to form a rabbet 344 along the perimeter of external surface 342′ except where body 262 of mounting base 260 is located. Rabbet 344 further includes a series of spaced apart ridges 345 with each pair of ridges 345 forming a groove 346 therebetween. This series of ridges 345 and grooves 346 are configured to receive series of ridges 335 and grooves 336 located on top adaptor housing 320 to ensure that top adaptor housing 320 and bottom adaptor housing 340 are properly oriented to one another during assembly.

Still referring to FIG. 10D, first adaptor conductive strip 350 of an adaptor assembly disclosed herein comprises body 352 with a first end 353 and a second end 354 opposite first end 353, body 353 also having one or more through holes 359 positioned, sized and dimensioned to receive one or more conductive strip pins 348. A prong tab 354 arises perpendicular from first end 353 and an integral plug tab 358 arises perpendicular from second end 354, with prong tab 354 configured in the opposite direction to integral plug tab 358. Similarly, second adaptor conductive strip 360 comprises body 362 with a first end 363 and a second end 364 opposite first end 363 body 363 also having one or more through holes 369 positioned, sized and dimensioned to receive one or more conductive strip pins 348. A prong tab 364 arises perpendicular from first end 363 and an integral plug tab 368 arises perpendicular from second end 364, with prong tab 364 configured in the opposite direction to integral plug tab 358. In some embodiments, as shown in FIG. 14, integral plug tabs 358, 368 each comprise a single tab configured to operationally receive first and second prongs 134, 135, respectively, in a manner where first and second prongs 134, 135 press against its respective integral plug tab 358, 368. In some embodiments, as shown in FIGS. 10D & 15, integral plug tabs 358, 368 each comprise two tabs parallel to each other and configured to operationally receive first and second prongs 134, 135, respectively, in a manner where first and second prongs 134, 135 are inserted between the two parallel tabs of its respective integral plug tab 358, 368.

When adaptor assembly 14 is assembled, first conductive strip 350 is properly aligned and positioned onto internal surface 341″ of top plate 341 of bottom adaptor housing 340 in a manner where 1) integral plug tab 358 is placed next to an opening located at a back end of first prong channel 270 in a manner that enables electrical communication of first prong 134 of integral plug 132 when operationally engaged with integral plug tab 358; 2) one or more conductive strip pins 348 are inserted one or more through holes 359; and 3) portions of body 352 are properly aligned and positioned against one or more conductive strip securing ridges 349. Similarly, second conductive strip 360 is properly aligned and positioned onto internal surface 341″ of top plate 341 of bottom adaptor housing 340 in a manner where 1) integral plug tab 368 is placed next to an opening located at a back end of second prong channel 272 in a manner that enables electrical communication of second prong 135 of integral plug 132 when operationally engaged with integral plug tab 368; 2) one or more conductive strip pins 348 are inserted one or more through holes 369; and 3) portions of body 362 are properly aligned and positioned against one or more conductive strip securing ridges 349.

In addition, adaptor plug assembly 290 is assembled to top adaptor housing 320 so that the internal portion of each adaptor plug extends substantially perpendicular from internal surface 321″ of bottom 321 with opposite side of each adaptor plug extending substantially perpendicular from external surface 321′ of bottom 321. For example, and referring to FIG. 10A, internal portion 293′ of first adaptor prong 293 is inserted into first electrical plug port 323 so that internal portion 293′ extends substantially perpendicular from internal surface 321″ of bottom 321 with opposite side of first adaptor prong 293 extending substantially perpendicular from external surface 321′ of bottom 321. Similarly, internal portion 295′ of second adaptor prong 295 is inserted into second electrical plug port 324 so that internal portion 295′ extends substantially perpendicular from internal surface 321″ of bottom 321 with opposite side of first adaptor prong 295 extending substantially perpendicular from external surface 321′ of bottom 321. Likewise, and referring to FIG. 10B, internal portion 303′ of first adaptor prong 303 is inserted into first electrical plug port 325 so that internal portion 303′ extends substantially perpendicular from internal surface 321″ of bottom 321 with opposite side of first adaptor prong 303 extending substantially perpendicular from external surface 321′ of bottom 321. Similarly, internal portion 305′ of second adaptor prong 305 is inserted into second electrical plug port 326 so that internal portion 305′ extends substantially perpendicular from internal surface 321″ of bottom 321 with opposite side of first adaptor prong 305 extending substantially perpendicular from external surface 321′ of bottom 321. Likewise, and referring to FIG. 10C, internal portion 313′ of first adaptor prong 313 is inserted into first electrical plug port 327 so that internal portion 313′ extends substantially perpendicular from internal surface 321″ of bottom 321 with opposite side of first adaptor prong 313 extending substantially perpendicular from external surface 321′ of bottom 321. Similarly, internal portion 315′ of second adaptor prong 315 is inserted into second electrical plug port 328 so that internal portion 315′ extends substantially perpendicular from internal surface 321″ of bottom 321 with opposite side of first adaptor prong 315 extending substantially perpendicular from external surface 321′ of bottom 321.

Assembled bottom adaptor housing 340 is then fitted over top adaptor housing 320 so that 1) each adaptor conductive strip operationally contacts its respective connector of each adaptor prong; 2) each housing securing pin 347 is inserted into the blind hole of each respective securing post 337; 3) front side 264 of top adaptor housing 320 is properly fitted onto body 262 of mounting base 260; and 4) series of ridges 345 and grooves 346 located on external surface 342′ of side 342 is properly fitted to series of ridges 335 and grooves 336 located on internal surface 322″ of side 322 so that each ridge 345 are inserted into its corresponding grove 336 and each ridge 335 are inserted into its corresponding grove 346. Once assembled, internal chamber 338 is formed. With respect to electrical plug 292, connector 294 of first adaptor prong 293 is in operational contact with prong tab 356 of first adaptor contact strip 350 in a manner that enables electrical communication of connector 294 with prong tab 356 and connector 296 of second adaptor prong 295 is in operational contact with prong tab 366 of second adaptor contact strip 360 in a manner that enables electrical communication of connector 296 with prong tab 366. With respect to electrical plug 302, connector 304 of first adaptor prong 303 is in operational contact with prong tab 356 of first adaptor contact strip 350 in a manner that enables electrical communication of connector 304 with prong tab 356 and connector 306 of second adaptor prong 305 is in operational contact with prong tab 366 of second adaptor contact strip 360 in a manner that enables electrical communication of connector 306 with prong tab 366. With respect to electrical plug 312, connector 314 of first adaptor prong 313 is in operational contact with prong tab 356 of first adaptor contact strip 350 in a manner that enables electrical communication of connector 314 with prong tab 356 and connector 316 of second adaptor prong 315 is in operational contact with prong tab 366 of second adaptor contact strip 360 in a manner that enables electrical communication of connector 316 with prong tab 366.

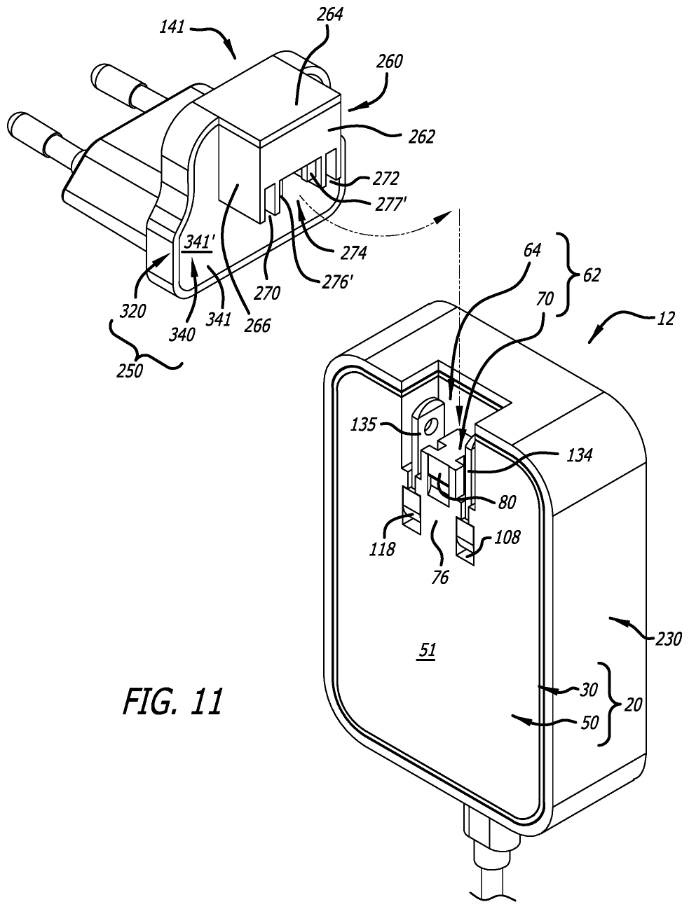

Attachment of adaptor assembly 14 to charger 12 is shown in FIGS. 11 & 12. Referring to FIGS. 8 & 11, integral plug 132 is placed in a second plug position, as discussed below, so that first and second prongs 134, 135 of integral plug 132 are positioned inside adapter mounting slot 64 and being substantially parallel to charger housing bottom 50. Mounting base 260 of adaptor assembly 14 is aligned with adaptor mount 62 of charger 12 in a manner that mounting base 260 can be inserted into adaptor mount 62. With back side 265 of mounting base 260 facing front opening 69 of adaptor mount 62, first side 266 of mounting base 260 is aligned with first side 66 of adaptor mount 62, second side 267 of mounting base 260 is aligned with second side 67 of adaptor mount 62, third side 268 of mounting base 260 is aligned with third side 68 of adaptor mount 62, ridge 276′ of latch lock slot 274 is aligned with groove 74, and ridge 277′ of latch lock slot 274 is aligned with groove 77. Once aligned, mounting base 260 is inserted into adaptor mounting slot 64 of mounting slot 64 in a manner that first prong 134 of integral plug 132 is inserted into first prong channel 270 of mounting base 260, second prong 135 of integral plug 132 is inserted into second prong channel 272 of mounting base 260, and latch lock 280 of mounting base 260 releasably engages with latch box 80 of adaptor mounting plug 70 of adaptor mount 62.

With respect to proper engagement of integral plug 132 to mounting base 260, first prong 134 of integral plug 132 is inserted through an opening located at a back end of first prong channel 270 until first prong 134 insets within and establishes operational contact with integral plug tab 358 of first adaptor conductive strip 350 in a manner that enables electrical communication of first prong 134 with integral plug tab 358. Similarly, second prong 135 of integral plug 132 is inserted through an opening located at a back end of second prong channel 272 until second prong 135 insets within and establishes operational contact with integral plug tab 368 of second adaptor conductive strip 360 in a manner that enables electrical communication of second prong 135 with integral plug tab 368. In this configuration, electrical communication is established between adaptor plug assembly 290 and integral plug 132.

With respect to proper engagement of latch lock 280 to latch box 80, and referring to FIGS. 8 & 9, first and second rails 282, 283 of latch lock 280 are initially aligned with channel 81 of latch box 80, with first rail 282 located inside of first side 82 of channel 81 and second rail 283 located inside of second side 83 of channel 81. As latch lock 280 is inserted further into adaptor mounting plug 70, bolt 284 of latch lock 280 aligned with and moves over engagement box 84 of latch box 80 causing bolt 284 to forcibly seat within engagement box 84, due to the mechanical pressure exerted by bolt 284 due to the constraining space of channel 81, in a manner where leading face 85 of engagement box 84 abuts leading edge 285 of bolt 284, bottom face 86 of engagement box 84 abuts top edge 286 of bolt 284, and trailing face 87 of engagement box 84 abuts trailing edge 287 of bolt 284.

Removal of adaptor assembly 14 to charger 12 is simply a reversal of attachment. A user applies external force to adaptor assembly 14 in a direction parallel to top 31 of charger housing top 30 and outward from first side 33 of charger housing top 30. This external force will disengage first prong 134 of integral plug 132 from first prong channel 270, disengage second prong 135 of integral plug 132 from second prong channel 270, and disengage bolt 282 from engagement box 83 in a manner that enables mounting base 60 to slide away from adaptor mounting plug 70 and adaptor mounting slot 64 and out of adaptor mount 62.

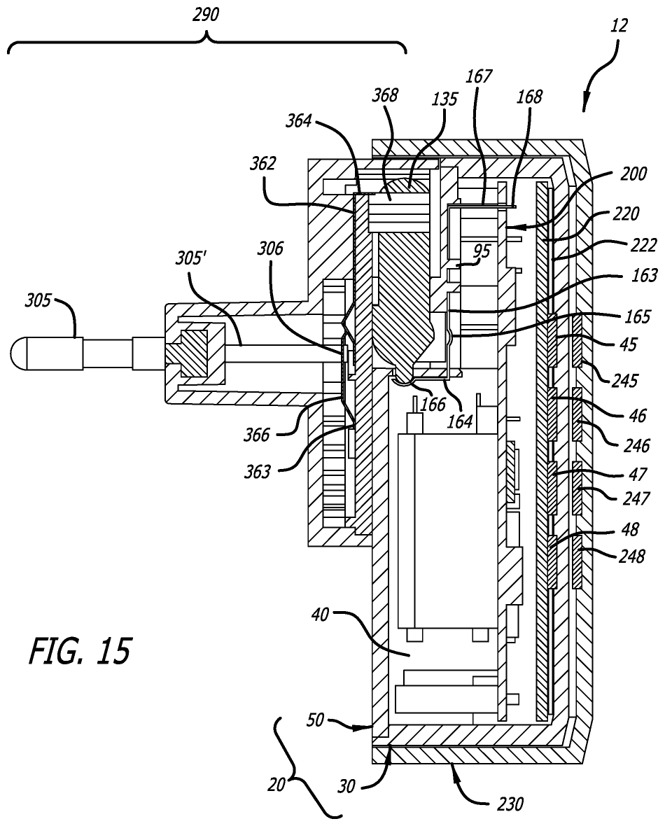

Operationally, integral plug 132 can be placed into one of two operational positions, a first” position (also referred to as an “out” or “up” position) and a second plug position (also referred to as an “in” or “down” position). FIGS. 13 & 14 are cross-sectional views of one exemplary embodiment of charger 12 fitted with removeable cover 230, with FIG. 13 taken along line 13-13 of FIG. 1 and FIG. 14 taken along line 14-14 of FIG. 12, whereas FIG. 15 is a cross-sectional view of another exemplary embodiment charger 12 fitted with removeable cover 230. When in a first plug position, integral plug 132 flipped out with first and second prongs 134, 135 being substantially perpendicular to charger housing bottom 50. For example, solid lines of FIG. 13 depict second prong 135 of integral plug 132 when in a first plug position. In this first orientation, second conductive projection 137 of second prong 135 is positioned and seated into first seat 165 of elongated portion 163 of second conductive strip 162. Second circuit board connector 167 of elongated portion 163 of second conductive strip 162 is shown in communication with circuit board 200. Although not shown in FIG. 13, a similar arrangement occurs with first prong 134 of integral plug 132, first conductive projection 136 of first prong 134 is positioned and seated into first seat 155 of elongated portion 153 of second conductive strip 152. First circuit board connector 157 of elongated portion 153 of first conductive strip 152 is shown in communication with circuit board 200, with circuit board 200 in communication with battery 206 and/or power port 208. In this first plug position, integral plug 132 is in electrical communication with battery 206 or power port 208 of circuit board 200. This enables charger 12 to directly use integral plug 132 by plugging integral plug 132 into any compatible electric outlet to charge battery 206 and/or supply electrical power to a device through power cord 16.

Referring to FIGS. 13-15, dashed broken lines of FIG. 13 depict second prong 135 of integral plug 132 when in a second plug position while solid lines of FIGS. 14 & 15 depict second prong 135 of integral plug 132 when in a second plug position. When in a second plug position, integral plug 132 is flipped in with first and second prongs 134, 135 positioned inside adapter mounting slot 64 and being substantially parallel to charger housing bottom 50. In this second orientation, second conductive projection 137 of second prong 135 is positioned and seated into second seat 166 of elongated portion 163 of second conductive strip 162. Second circuit board connector 167 of elongated portion 163 of second conductive strip 162 remains in communication with circuit board 200. Although not shown in FIGS. 13-15, a similar arrangement occurs with first prong 134 of integral plug 132, first conductive projection 136 of first prong 134 is positioned and seated into second seat 156 of elongated portion 153 of second conductive strip 152 and first circuit board connector 157 of elongated portion 153 of first conductive strip 152 remains in communication with circuit board 200. In this second plug position, integral plug 132 remains in electrical communication with battery 206 of electrical board 200.

In addition, when in the second plug position, charger 12 can now operationally receive an adaptor assembly disclosed herein having adaptor plug assembly 290, such as, e.g., adaptor assembly 14, 14′, or 14″ having adaptor plug assembly 290 with the desired electrical plug standard, such as, e.g., adaptor plug 292, 302, or 312, respectively. For example, and as shown in FIG. 14, adaptor 14′ having adaptor plug assembly 290 with adaptor plug 302 is operationally engaged with charger 12. Second prong 135 of integral plug 132 is in electrical communication with second adaptor conductive strip 360 thereby completing the circuit from adaptor plug 302 to second adaptor conductive strip 360 to integral plug 132 to conductive strip assembly 150 comprising first and second conductive strips 152, 162, to circuit board 200 to battery 206 or power port 208. Although not shown in FIG. 14, a similar arrangement occurs with first prong 133 of integral plug 132 in that first prong 133 is in electrical communication with first adaptor conductive strip 350 thereby completing the circuit from adaptor plug 302 to first adaptor conductive strip 350 to integral plug 132 to conductive strip assembly 150 comprising first and second conductive strips 152, 162, to circuit board 200 to battery 206 or power port 208. In this second plug position, adaptor plug assembly 290 is in electrical communication with battery 206 and power port 208 of circuit board 200. This enables charger 12 to use adaptor assembly 14 by plugging adaptor plug assembly 290 into any compatible electric outlet to charge battery 206 and/or supply electrical power to a device through power cord 16.

Aspects of the present specification disclose a kit. A kit disclosed herein can comprise charger system 10, with charger system 10 comprising a charger 12, with or without removeable cover 230, one or more adapter assemblies 14, one or more removeable covers 230, a power cord 16, or any combination or number thereof. In some embodiments, a kit disclosed herein comprises charger system 10 comprising a charger 12 with removeable cover 230 and one or more adapter assemblies 14. In some embodiments, a kit disclosed herein comprises charger system 10 comprising a charger 12 with removeable cover 230, one or more adapter assemblies 14, and a power cord 16. In some embodiments, a kit disclosed herein comprises charger system 10 comprising a charger 12 with removeable cover 230, one or more additional removeable covers 230, one or more adapter assemblies 14, and a power cord 16. In some embodiments, a kit disclosed herein comprises charger system 10 comprising a charger 12 without removeable cover 230, one or more additional removeable covers 230, and one or more adapter assemblies 14. In some embodiments, a kit disclosed herein comprises charger system 10 comprising a charger 12 without removeable cover 230, one or more additional removeable covers 230, one or more adapter assemblies 14, and a power cord 16.

In some embodiments, a kit disclosed herein can comprise one or more containers containing each of the individual components, such as, e.g., charger 12, each of one or more adaptor assemblies 14, each of one or more removeable covers 230, a power cord 16, separately or in combinations thereof. For example, a kit can comprise one container including charger 12 with removeable cover 230 and a second container including one or more additional removeable covers 230. The remainder of the components such as one or more adapter assemblies 14, may be included in either the first or second container, or may be separately included in at least a third container. Packaging of individual components into separate containers can assist protecting and storage of individual components of charger system 10. A kit disclosed herein can also comprise a set of instructions which may include information useful to the end user such as how to use charger 12, how to mount/remove adapter assembly 14, how to mount/remove removeable cover 230, how to engage plug 17 of power cord 16 to power port 208 of charger 12, and/or how to safely operate charger system 10. The contents of a kit disclosed herein are typically enclosed in an outer casing. An outer casing disclosed herein can be a box, a sealed bag, a foil pouch, etc. In some embodiments, a kit disclosed herein is enclosed in a box. In some embodiments, a kit disclosed herein is enclosed in an outer casing comprising a clear hard plastic front portion and a cardboard back portion.

It is anticipated that the disclosed subject matter can be any part or combination of parts, portion or any combination of portions, element, or combination of elements of a charger system disclosed herein, a charger disclosed herein, an adaptor assembly disclosed herein, a removeable cover disclosed herein, a power cord disclosed herein, and a kit disclosed herein.

Aspects of the present specification can also be described by the following embodiments:
1. A charger comprising a charger housing bottom, a circuit board, a charger housing top, and a removeable cover, a charger housing bottom including a plug housing assembly containing an integral plug assembly, the integral plug assembly comprising an integral plug having at least one prong and at least one conductive strip having a first end and a second end, the integral plug capable of being reversibly moved to a first plug position or a second plug position, the at least one conductive strip being in continuous communication with the integral plug, the at least one conductive strip being configured to engage the integral plug at a first conductive strip seat when the integral plug is in the first plug position or a second conductive strip seat when the integral plug is in the second plug position; the circuit board being connected to and in communication with the first end of the at least one conductive strip; a charger housing top fixedly connected to the charger housing bottom; and a removeable cover sized and configured to releasably encase the charger housing top.
2. The charger according to claim 1, wherein the integral plug comprises a first prong and a second prong, and the at least one conductive strip comprises a first conductive strip and a second conductive strip, wherein the first and second conductive strips are each in continuous communication with the integral plug, the first and second conductive strips each being configured to engage the integral plug at a first conductive strip seat when the integral plug is in the first plug position or a second conductive strip seat when the integral plug is in the second plug position.
3. The charger according to claim 1 or 2, wherein the charger housing top further includes at least one charger magnet and the removeable cover further includes at least one cover magnet, the least one charger magnet being in substantial alignment and proximity with the at least one cover magnet when the removeable cover is fitted onto the charger housing top, thereby providing an attractive magnetic force to enable releasable securing between the charger housing top and the removeable cover.
4. The charger according to any one of claims 1-3, wherein the plug housing assembly further includes an adapter mount dimensioned and configured to receive an adaptor assembly.
5. The charger according to any one of claims 1-4, wherein the circuit board further includes a heat shield, an electromagnetic shield or both.
6. The charger according to any one of claims 1-5, wherein the charger housing top further includes a ferrite shield.
7. The charger according to any one of claims 1-6, wherein the removeable cover further includes a protective pad.
8. A charger system comprising a charger and at least one adaptor assembly, the charger comprising a charger housing bottom, a circuit board, a charger housing top, and a removeable cover, a charger housing bottom including a plug housing assembly containing an integral plug assembly and an adapter mount, the integral plug assembly comprising an integral plug having at least one prong and at least one conductive strip having a first end and a second end, the integral plug capable of being reversibly moved to a first plug position or a second plug position, the at least one conductive strip being in continuous communication with the integral plug, the at least one conductive strip being configured to engage the integral plug at a first conductive strip seat when the integral plug is in the first plug position or a second conductive strip seat when the integral plug is in the second plug position; the adapter mount being dimensioned and configured to receive the at least one adapter assembly, the circuit board being connected to and in communication with the first end of the at least one conductive strip; a charger housing top fixedly connected to the charger housing bottom; and a removeable cover sized and configured to releasably encase the charger housing top, the at least one adapter assembly each comprising a mounting base and an adaptor plug assembly, the mounting base being dimensioned and configured to releasably engage the adaptor mount of the plug housing assembly, and the adaptor plug assembly comprising an adaptor plug having at least one adaptor prong, the adaptor plug assembly having an electrical plug standard different than that of the integral plug.
9. The charger system according to claim 8, wherein the charger housing bottom comprises at least one prong channel dimensioned and configured to receive the at least one prong of the integral plug when the integral plug in in the second plug position.
10. The charger system according to claim 8 or 9, wherein the integral plug comprises a first prong and a second prong, and the at least one conductive strip comprises a first conductive strip and a second conductive strip, wherein the first and second conductive strips are each in continuous communication with the integral plug, the first and second conductive strips each being configured to engage the integral plug at a first conductive strip seat when the integral plug is in the first plug position or a second conductive strip seat when the integral plug is in the second plug position.
11. The charger system according to claim 10, wherein the charger housing bottom comprises a first prong channel dimensioned and configured to receive the first prong of the integral plug when the integral plug in in the second plug position and a second prong channel dimensioned and configured to receive the second prong of the integral plug when the integral plug in in the second plug position.
12. The charger system according to any one of claims 8-11, wherein the adaptor mount includes an adaptor mounting slot and an adaptor mounting plug and the mounting base includes a latch lock assembly including a latch lock slot, the adaptor mounting plug being dimensioned and configured to releasably engage the latch lock assembly by inserting the adaptor mounting plug into the latch lock slot.
13. The charger system according to claim 12, wherein the adaptor mounting plug further comprises a latch box and the latch lock assembly further comprises a bolt, the bolt being dimensioned and configured to releasably engage the latch box.
14. The charger system according to any one of claims 8-13, wherein each of the at least one adapter assembly comprise at least one adaptor conductive strip, each of the at least one adaptor conductive strip having a first end and a second end, the first end being connected to and in communication with the at least one adaptor prong and the second end capable of being in communication with at least one prong of the integral plug when the at least one adapter assembly is operationally engaged to the charger.
15. The charger system according to claim 14, wherein the adaptor plug comprises a first adaptor prong and a second adaptor prong and at least one adaptor conductive strip comprises a first adaptor conductive strip and a second adaptor conductive strip, wherein the first end of the first adaptor conductive strip is connected to and in communication with the first adaptor prong and the second end of the first adaptor conductive strip is capable of being in communication with at least one prong of the integral plug when the at least one adapter assembly is operationally engaged to the charger, and wherein the first end of the second adaptor conductive strip is connected to and in communication with the second adaptor prong and the second end of the second adaptor conductive strip is capable of being in communication with at least one prong of the integral plug when the at least one adapter assembly is operationally engaged to the charger
16. The charger system according to any one of claims 8-15 wherein the electrical plug standard an Australian electrical plug standard, an European Union electrical plug standard, or an United Kingdom electrical plug standard.
17. The charger system according to any one of claims 8-16, wherein the charger housing top further includes at least one charger magnet and the removeable cover further includes at least one cover magnet, the least one charger magnet being in substantial alignment and proximity with the at least one cover magnet when the removeable cover is fitted onto the charger housing top, thereby providing an attractive magnetic force to enable releasable securing between the charger housing top and the removeable cover.
18. The charger system according to any one of claims 8-17, wherein the at least one charger magnet comprises a first charger magnet, a second charger magnet and a third charger magnet and the at least one cover magnet comprises a first cover magnet, a second cover magnet and a third cover magnet
19. The charger system according to any one of claims 8-18, further comprising one or more additional removable covers, a power cord, or both, the one or more additional removeable covers being sized and configured to releasably encase the charger housing top.
20. The charger system according to claim 16, wherein each of the one or more additional removeable cover further includes at least one cover magnet, the at least one cover magnet being in substantial alignment and proximity to the least one charger magnet when one of the one or more additional removeable cover is fitted onto the charger housing top, thereby providing an attractive magnetic force to enable releasable securing between the charger housing top and the one or more additional removeable covers.
21. A charger system according to claim 20, wherein each of the one or more additional removeable covers includes indicia thereon, the indicia on each of the one or more additional removeable covers being different than indicia present of the removeable cover or the other one or more additional removeable covers.
22. The charger system according to any one of claims 8-21, wherein the removeable cover is a color different than the color of the charger housing top and/or charger housing bottom.
23. The charger according to any one of claims 8-22, wherein the circuit board further includes a heat shield, an electromagnetic shield or both.
24. The charger according to any one of claims 8-23, wherein the charger housing top further includes a ferrite shield.
25. The charger according to any one of claims 8-24, wherein the removeable cover further includes a protective pad.
26. A charger kit, comprising a charger and at least one adaptor assembly, the charger comprising a charger housing bottom, a circuit board, a charger housing top, and a removeable cover, a charger housing bottom including a plug housing assembly containing an integral plug assembly and an adapter mount, the integral plug assembly comprising an integral plug having at least one prong and at least one conductive strip having a first end and a second end, the integral plug capable of being reversibly moved to a first plug position or a second plug position, the at least one conductive strip being in continuous communication with the integral plug, the at least one conductive strip being configured to engage the integral plug at a first conductive strip seat when the integral plug is in the first plug position or a second conductive strip seat when the integral plug is in the second plug position; the adapter mount being dimensioned and configured to receive the at least one adapter assembly, the circuit board being connected to and in communication with the first end of the at least one conductive strip; a charger housing top fixedly connected to the charger housing bottom; and a removeable cover sized and configured to releasably encase the charger housing top, the at least one adapter assembly each comprising a mounting base and an adaptor plug assembly, the mounting base being dimensioned and configured to releasably engage the adaptor mount of the plug housing assembly, and the adaptor plug assembly comprising an adaptor plug having at least one adaptor prong, the adaptor plug assembly having an electrical plug standard different than that of the integral plug.
27. The charger kit according to claim 26, further comprising one or more additional removeable covers, at least one power cord, or both.

In closing, foregoing descriptions of embodiments of the present invention have been presented for the purposes of illustration and description. It is to be understood that, although aspects of the present invention are highlighted by referring to specific embodiments, one skilled in the art will readily appreciate that these described embodiments are only illustrative of the principles comprising the present invention. As such, the specific embodiments are not intended to be exhaustive or to limit the invention to the precise forms disclosed. Therefore, it should be understood that embodiments of the disclosed subject matter are in no way limited to a particular element, compound, composition, component, article, apparatus, methodology, use, protocol, step, and/or limitation described herein, unless expressly stated as such.

In addition, groupings of alternative embodiments, elements, steps and/or limitations of the present invention are not to be construed as limitations. Each such grouping may be referred to and claimed individually or in any combination with other groupings disclosed herein. It is anticipated that one or more alternative embodiments, elements, steps and/or limitations of a grouping may be included in, or deleted from, the grouping for reasons of convenience and/or patentability. When any such inclusion or deletion occurs, the specification is deemed to contain the grouping as modified, thus fulfilling the written description of all Markush groups used in the appended claims.

Furthermore, those of ordinary skill in the art will recognize that certain changes, modifications, permutations, alterations, additions, subtractions and sub-combinations thereof can be made in accordance with the teachings herein without departing from the spirit of the present invention. Furthermore, it is intended that the following appended claims and claims hereafter introduced are interpreted to include all such changes, modifications, permutations, alterations, additions, subtractions and sub-combinations as are within their true spirit and scope. Accordingly, the scope of the present invention is not to be limited to that precisely as shown and described by this specification.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

The words, language, and terminology used in this specification is for the purpose of describing particular embodiments, elements, steps and/or limitations only and is not intended to limit the scope of the present invention, which is defined solely by the claims. In addition, such words, language, and terminology are to be understood not only in the sense of their commonly defined meanings, but to include by special definition in this specification structure, material or acts beyond the scope of the commonly defined meanings. Thus, if an element, step or limitation can be understood in the context of this specification as including more than one meaning, then its use in a claim must be understood as being generic to all possible meanings supported by the specification and by the word itself.

The definitions and meanings of the elements, steps or limitations recited in a claim set forth below are, therefore, defined in this specification to include not only the combination of elements, steps or limitations which are literally set forth, but all equivalent structure, material or acts for performing substantially the same function in substantially the same way to obtain substantially the same result. In this sense it is therefore contemplated that an equivalent substitution of two or more elements, steps and/or limitations may be made for any one of the elements, steps or limitations in a claim set forth below or that a single element, step or limitation may be substituted for two or more elements, steps and/or limitations in such a claim. Although elements, steps or limitations may be described above as acting in certain combinations and even initially claimed as such, it is to be expressly understood that one or more elements, steps and/or limitations from a claimed combination can in some cases be excised from the combination and that the claimed combination may be directed to a sub-combination or variation of a sub-combination. As such, notwithstanding the fact that the elements, steps and/or limitations of a claim are set forth below in a certain combination, it must be expressly understood that the invention includes other combinations of fewer, more or different elements, steps and/or limitations, which are disclosed in above combination even when not initially claimed in such combinations. Furthermore, insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. Accordingly, the claims are thus to be understood to include what is specifically illustrated and described above, what is conceptually equivalent, what can be obviously substituted and also what essentially incorporates the essential idea of the invention.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. For instance, as mass spectrometry instruments can vary slightly in determining the mass of a given analyte, the term “about” in the context of the mass of an ion or the mass/charge ratio of an ion refers to +/−0.50 atomic mass unit. At the very least, and not as an attempt to limit the application of the doctrine of equivalents to the scope of the claims, each numerical indication should at least be construed in light of the number of reported significant digits and by applying ordinary rounding techniques.

Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as, e.g., “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising”, variations thereof such as, e.g., “comprise” and “comprises”, and equivalent open-ended transitional phrases thereof like “including”, “containing” and “having”, encompass all the expressly recited elements, limitations, steps, integers, and/or features alone or in combination with unrecited subject matter; the named elements, limitations, steps, integers, and/or features are essential, but other unnamed elements, limitations, steps, integers, and/or features may be added and still form a construct within the scope of the claim. Specific embodiments disclosed herein may be further limited in the claims using the closed-ended transitional phrases “consisting of” or “consisting essentially of” (or variations thereof such as, e.g., “consist of”, “consists of”, “consist essentially of”, and “consists essentially of”) in lieu of or as an amendment for “comprising.” When used in the claims, whether as filed or added per amendment, the closed-ended transitional phrase “consisting of” excludes any element, limitation, step, integer, or feature not expressly recited in the claims. The closed-ended transitional phrase “consisting essentially of” limits the scope of a claim to the expressly recited elements, limitations, steps, integers, and/or features and any other elements, limitations, steps, integers, and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps, integers, and/or features specifically recited in the claim, whereas the meaning of the closed-ended transitional phrase “consisting essentially of” is being defined as only including those elements, limitations, steps, integers, and/or features specifically recited in the claim and those elements, limitations, steps, integers, and/or features that do not materially affect the basic and novel characteristic(s) of the claimed subject matter. Therefore, the open-ended transitional phrase “comprising” (and equivalent open-ended transitional phrases thereof) includes within its meaning, as a limiting case, claimed subject matter specified by the closed-ended transitional phrases “consisting of” or “consisting essentially of.” As such, the embodiments described herein or so claimed with the phrase “comprising” expressly and unambiguously provide description, enablement, and support for the phrases “consisting essentially of” and “consisting of.”

Lastly, all patents, patent publications, and other references cited and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. The reference to any prior art in this specification is not, and should not be taken as, an acknowledgement or any form of suggestion that the prior art forms part of the common general knowledge from any country. In addition, nothing in this regard is or should be construed as an admission that the inventors are not entitled to antedate such disclosure by virtue of prior invention or for any other reason. All statements as to the date or representation as to the contents of these documents are based on the information available to the applicant and do not constitute any admission as to the correctness of the dates or contents of these documents.

1. A charger comprising a charger housing bottom, a circuit board, a charger housing top, and a removeable cover,
a charger housing bottom including a plug housing assembly containing an integral plug assembly and an adapter mount,
the integral plug assembly comprising an integral plug having at least one prong and at least one conductive strip having a first end and a second end,
the integral plug capable of being reversibly moved to a first plug position or a second plug position,
the at least one conductive strip being in continuous communication with the integral plug, the at least one conductive strip being configured to engage the integral plug at a first conductive strip seat when the integral plug is in the first plug position or a second conductive strip seat when the integral plug is in the second plug position;
the adapter mount being dimensioned and configured to receive the at least one adapter assembly,
the circuit board being connected to and in communication with the first end of the at least one conductive strip;
a charger housing top fixedly connected to the charger housing bottom; and
a removeable cover sized and configured to releasably encase the charger housing top.

2. The charger according to claim 1, wherein the integral plug comprises a first prong and a second prong, and the at least one conductive strip comprises a first conductive strip and a second conductive strip, wherein the first and second conductive strips are each in continuous communication with the integral plug, the first and second conductive strips each being configured to engage the integral plug at a first conductive strip seat when the integral plug is in the first plug position or a second conductive strip seat when the integral plug is in the second plug position.

3. The charger according to claim 1, wherein the charger housing top further includes at least one charger magnet and the removeable cover further includes at least one cover magnet, the least one charger magnet being in substantial alignment and proximity with the at least one cover magnet when the removeable cover is fitted onto the charger housing top, thereby providing an attractive magnetic force to enable releasable securing between the charger housing top and the removeable cover.

4. The charger according to claim 1, wherein the plug housing assembly further includes an adapter mount dimensioned and configured to receive an adaptor assembly.

5. The charger according to claim 1, wherein the circuit board further includes a heat shield, an electromagnetic shield or both.

6. The charger according to claim 1, wherein the charger housing top further includes a ferrite shield.

7. The charger according to claim 1, wherein the removeable cover further includes a protective pad.

8. A charger system comprising a charger as defined in claim 1, and at least one adaptor assembly, the at least one adapter assembly each comprising a mounting base and an adaptor plug assembly,
the mounting base being dimensioned and configured to releasably engage the adaptor mount of the plug housing assembly, and
the adaptor plug assembly comprising an adaptor plug having at least one adaptor prong, the adaptor plug assembly having an electrical plug standard different than that of the integral plug.

9. The charger system according to claim 8, wherein the adaptor mount includes an adaptor mounting slot and an adaptor mounting plug and the mounting base includes a latch lock assembly including a latch lock slot, the adaptor mounting plug being dimensioned and configured to releasably engage the latch lock assembly by inserting the adaptor mounting plug into the latch lock slot.

10. The charger system according to claim 8, wherein each of the at least one adapter assembly comprise at least one adaptor conductive strip, each of the at least one adaptor conductive strip having a first end and a second end, the first end being connected to and in communication with the at least one adaptor prong and the second end capable of being in communication with at least one prong of the integral plug when the at least one adapter assembly is operationally engaged to the charger.

11. The charger system according to claim 8, wherein the electrical plug standard an Australian electrical plug standard, an European Union electrical plug standard, or an United Kingdom electrical plug standard.

12. The charger system according to claim 8, wherein the charger housing top further includes at least one charger magnet and the removeable cover further includes at least one cover magnet, the least one charger magnet being in substantial alignment and proximity with the at least one cover magnet when the removeable cover is fitted onto the charger housing top, thereby providing an attractive magnetic force to enable releasable securing between the charger housing top and the removeable cover.

13. The charger system according to claim 8, wherein the at least one charger magnet comprises a first charger magnet, a second charger magnet and a third charger magnet and the at least one cover magnet comprises a first cover magnet, a second cover magnet and a third cover magnet.

14. The charger system according to claim 8, further comprising one or more additional removable covers, a power cord, or both, the one or more additional removeable covers being sized and configured to releasably encase the charger housing top.

15. The charger system according to claim 14, wherein each of the one or more additional removeable cover further includes at least one cover magnet, the at least one cover magnet being in substantial alignment and proximity to the least one charger magnet when one of the one or more additional removeable cover is fitted onto the charger housing top, thereby providing an attractive magnetic force to enable releasable securing between the charger housing top and the one or more additional removeable covers.

16. The charger system according to claim 8, wherein the removeable cover is a color different than the color of the charger housing top and/or charger housing bottom.

17. The charger according to claim 8, wherein the circuit board further includes a heat shield, an electromagnetic shield or both.

18. The charger according to claim 8, wherein the charger housing top further includes a ferrite shield.

19. The charger according to claim 8, wherein the removeable cover further includes a protective pad.

20. A charger kit, comprising a charger and at least one adaptor assembly
the charger comprising a charger housing bottom, a circuit board, a charger housing top, and a removeable cover,
a charger housing bottom including a plug housing assembly containing an integral plug assembly and an adapter mount,
the integral plug assembly comprising an integral plug having at least one prong and at least one conductive strip having a first end and a second end,
the integral plug capable of being reversibly moved to a first plug position or a second plug position,
the at least one conductive strip being in continuous communication with the integral plug, the at least one conductive strip being configured to engage the integral plug at a first conductive strip seat when the integral plug is in the first plug position or a second conductive strip seat when the integral plug is in the second plug position;
the adapter mount being dimensioned and configured to receive the at least one adapter assembly,
the circuit board being connected to and in communication with the first end of the at least one conductive strip;
a charger housing top fixedly connected to the charger housing bottom; and
a removeable cover sized and configured to releasably encase the charger housing top,
the at least one adapter assembly each comprising a mounting base and an adaptor plug assembly,
the mounting base being dimensioned and configured to releasably engage the adaptor mount of the plug housing assembly, and
the adaptor plug assembly comprising an adaptor plug having at least one adaptor prong, the adaptor plug assembly having an electrical plug standard different than that of the integral plug.
